(19) United States
(12) Patent Application Publication
(10) Pub. No.: US 2015/0081396 A1
(43) Pub. Date: Mar. 19, 2015

(54) SYSTEM AND METHOD FOR OPTIMIZING BUSINESS PERFORMANCE WITH AUTOMATED SOCIAL DISCOVERY

(71) Applicant: Edwin Andrew MILLER, Leesburg, VA (US)

(72) Inventor: Edwin Andrew MILLER, Leesburg, VA (US)

(21) Appl. No.: 14/489,225

(22) Filed: Sep. 17, 2014

Related U.S. Application Data
(63) Continuation-in-part of application No. 14/030,815, filed on Sep. 18, 2013, now abandoned.

(51) Int. Cl. G06Q 10/06; H04L 12/24; G06F 17/30

(52) U.S. Cl. CPC G06Q 10/0637; G06F 17/30289; G06F 17/30386; G06F 17/30699; H04L 41/22
USPC 705/7.36; 707/802; 707/758; 707/754

(57) ABSTRACT

A system, process and method for automatically collecting, collating and transforming data into useful formats and displaying or otherwise outputting the transformed data into useable information. The system provides outputs that are useful in optimizing the enterprise performance of a business. The system, process and method are grounded in an established logical framework for systematically classifying areas of business concerns.

### RELATED APPLICATIONS

The present application is a continuation-in-part of U.S. application Ser. No. 14/030,815 entitled “SYSTEM AND METHOD FOR OPTIMIZING BUSINESS PERFORMANCE WITH AUTOMATED SOCIAL DISCOVERY,” filed on Sep. 18, 2013, the entirety of which is incorporated by reference herein.

### BACKGROUND

1. Field of Invention

The present invention relates to a system and method for identifying and qualifying sources of data, collecting, filtering and analyzing data and transforming the data into visual images associated with a selected framework that is useful as tool for managers to optimize enterprise performance.

2. Background of the Invention

Since the mid-20th century, the field of business and management has revolutionized business and industry. Beginning with consultants such as Peter Drucker and W. Edwards Deming, numerous authors and consultants have suggested frameworks for analyzing an enterprise to give management insight and provide tools to improve performance through, for example, enhanced clarity of roles, responsibilities, and expectations. Numerous “frameworks” have been suggested since that time, but the lack of systematic approach to gaining insight into all areas of an organization diminishes the usefulness of these frameworks.

Two distinct methodologies are commonly used to measure organizational effectiveness and collect information on the functional performance of business processes: outside business consultants and internal review processes. This approach to gaining insight into an enterprise is disconnected and disorganized.

When performance is measured based on external perspectives from consultants, individuals or a team conduct interviews of key executives in a company, review financials, and compare results to their established methodology. Expertise generated by consultancies is based on soft variables and subjective information provided by the consultancy. The actual methodology of consulting varies widely due to different established practices, varied strategic differences between internal opinions provided within the business community, and different institutional philosophies constructed on a variety of experiences uniquely shaped by the circumstances the individual consultancy encounters during their operation as a functional business. Consultancies produce results based on their varied methodologies and then provide executive recommendations based on their private findings. Typical consulting fees are quite expensive. This makes consultation an unattractive option for business managers unless they are forced into unfortunate circumstances that inhibit their operations or their strategic position is compromised in their own space within their operational market. In addition, the “learning” and recursive benefit that comes from in depth analysis of different organizations inures almost entirely to the outside consultants. Stated differently, the more engagements a consultant takes on the wider their knowledge base becomes. Learning form the best practices of one organization allows a consultant to better advise another organization with regard to benchmarking or best practices. However, the ability to share and benefit from this increased insight is controlled by the outside consultant. Moreover, protection of know how relating to best practices depends on the outside consultant. Organizations would plainly benefit from being able to capture for themselves some of these side benefits of in depth organizational analysis. Likewise, systemized benchmarking (as opposed to human benchmarking) improves the ability to control the dissemination of know how.

Business management might also choose to investigate optimization options by establishing internal review processes. Internal processes that businesses use to conduct performance reviews tend to be broad and disparate. An individual business might use performance reviews ranging from strategic off site based internal executive team evaluations to internal employee surveys. The variance among separate business entities is not of itself problematic. However, it is often the case that an individual business utilizes completely separate methods for collecting information. Initiatives typically target separated issues based on entirely different points of strategy. Data collection and management can also vary greatly. These methods are all disconnected from an overall perspective and lack organized means of comparing the performance of each method. Since these different methods cannot be universalized, it is difficult to examine the strategic importance of the information.

The absence of a systemized approach to data collection limits the ability to use the data to gain enterprise wide insight. Most data collected through consultants and internal review, assuming it is even translated into useful strategic insights for the business, is eventually neglected as of little value beyond the narrow case for collection. The disparate nature of the information means further limits the value of the data gathered in conventional internal review processes. Since there is no existing framework for organizing all of the information, none of the respective pieces of data have any larger meaning for the business. There is no methodology for universalizing the information to the broader implications of the business itself. Generated connect insights is difficult, if not impossible, with disconnected data.

Thus, there remains a need for a system and method for identifying, gathering and transforming useful data into a desired framework.

### SUMMARY OF THE INVENTION

The present invention provides a system and systematic approach (method) for identifying and qualifying sources of data, collecting, filtering and analyzing data and transforming the data into useful output (e.g., visual images and print outs) associated with a selected framework that is useful as tool for managers to optimize enterprise performance. As used here, a “framework” is an analytical structure for organized presentation of data that encompasses the assets, processes and structures that drive business success. Embodiments described herein refer to Edwin Miller's 9Lenses framework, but the invention may be applied to other frameworks as well. An aspect of the present invention provides a system, methods, processes, software, and standards designed to collect and collate information pertaining to the condition particular to the company that concern the successful operation of the company evaluated.

A challenge encountered by business leaders seeking to utilize a framework, (e.g., 9Lenses) is that data within and available to the organization is not directly applicable to the framework. Moreover, data that may be relevant or necessarily is not being collected. The invention provides a system and systematic approach for identifying, collecting and transforming available data into framework data. The system takes input from a wide variety of data sources, transforms the data by processing the input as necessary and mapping the input to a MAIN SCHEMA using a mapping engine. A transformation engine (analytics engine) may be used to transform or assist in transforming the MAIN SCHEMA data into a selected output framework (Business Context). The presentation format may be a “preset” format related to known or established business context or customized to meet a particular need.

The input data sources used may include both people providing input in response to surveys or data pulled from existing internal or external data sources. The people from whom data is obtained can be anyone connected with the enterprise: employees, managers, customers, vendors and any other stake holder. Existing internal data sources could include, for example, Enterprise resource planning (ERP) systems, human resource (HR) systems and operational systems. External data sources could include, for example, market intelligence and competitive rankings.

The output of the system, methods, processes, and software can be displayed (presented) in a format tailored to address specified problems based on criteria of assessing (1) immediate business pains (2) specific areas of concern (3) scope of the problem (4) potential returns for solutions to the problem. Information is then classified according to business complexity and immediate needs. Selections of the specific systems utilized under the framework are based on company preference, but recommendations are provided based on the inputs provided by the company. The raw data is persevered in association with the transformed data and the presentation of the data is hierarchically structured so that a user may see all available data at the highest transformed data level and then “drill down” into progressively lower levels so that raw data is at the lowest level of the hierarchy.

The output of the system, methods, processes, and software may include presentations of data transformed and applied according to a selected schema and may include the output of one or more software engines that provide useful business tools. For example, a recommendation engine may be provided to make recommendations based on the data and the selected schema. Likewise, a prediction engine may be provided to make predications based on the data and the selected schema. A comparison engine may be used to take system output and compare the output to a standard for that industry using a database that stores ideal metrics of that industry, i.e., compare actual to ideal. Based on signals from the comparison engine, the system may provide a visual signal [e.g., “red” “yellow” “green” display] to identify where the data presented lies on the spectrum of comparable organizations. Additionally, the comparison engine may provide recommended action-steps for using the data in strategic plans. A valuation engine may be used to generate a valuation of the enterprise based on the data.

The system also includes data filters that, for example, allow a user to turn off selected segments of data from the inputs. The segmentation of the data is based on preset organization of the data. This functionality allows the system to display outputs based on different combinations of segmented data from the inputs.

The present invention is applicable to a wide variety of business problems. Utilization can theoretically apply to any company operating with a multiplicity of employees, operations, functions, and systems. Meaningful insight is derived from the collection, development, and transformation of data based on the inputs, data aggregation, and systems. Outputs regarding the aforementioned problems functionally operate under the mechanism of the system logic (schema) in regard to how data is transformed into useful insight driving materials.

The tools provided by the invention may be applied to all business problems that can be articulated in a known context for procedural evaluation. Areas of application broadly concern market potential, market behaviors, competitor interests, human resource solutions, organizational design, financial resource management, business planning strategy, marketing planning, sales strategies, operational considerations, infrastructure planning, operational assessment, potential returns for investments, measures for assessment, performance assessments, stakeholder investigations, governance practices, and legal concerns. These issues all fit into the 9Lenses framework, called the schema. The invention develops solutions based on this framework.

Business problems under the framework function as points of evaluation. Points of evaluation are deployed in the system based on the working methods established. The specific systems, methods, processes, software, and standards utilized break down based on the workflow of the issue classification. Aggregated data functionally overrides strategic evaluation difficulties by automating data collection and transforming the simple data points into meaningful information with direct application to immediate concerns as well as applications to future problems. Additionally, by providing contextual understanding of comprehensive organizational structure, the data functions as a conceptual insight engine. Data aggregation reduces the operational and opportunity costs of strategic assessments while maximizing the valuation and visibility of potential solutions.

### BRIEF DESCRIPTION OF DRAWINGS

FIG. 1 is a schematic diagram illustrating an example architecture of the system.

FIG. 2 is a schematic diagram illustrating an example functional overview of the system.

FIG. 3 is an example process flow for how data in the system is transformed into actionable enterprise intelligence.

FIG. 3A is an illustration of a main schema and the accompanying output of from the system dashboard, in accordance with an aspect of the present invention.

FIG. 3B is an illustration of an example alternative output from the system dashboard.

FIG. 3C is an illustration of an example description of the main components of a main schema.

FIG. 4A is a schematic diagram of an example system for transforming various inputs of raw data into useable information within the schema.

FIG. 4B shows an aspect of the invention that allows the user the ability to control data outputs.

FIG. 4C is a schematic diagram of an example system used to measure various inputs and determine comparative analysis of the entire business operation.

FIG. 4D shows an alternative user interface for collecting inputs from users, in accordance with an aspect of the present invention.

FIG. 5 is a schematic diagram of an example system used in a process for evaluating and confirming business data inputs based on interpretative logic grounded in dynamic feedback loops.

FIG. 6 is a schematic diagram of an example system for collection, organization, schematization, storage and use of queries designed to elicit data pertaining to business problems into a universal database.

FIGS. 6A and 6B show a schematic diagram of an example system for storing external inputs from a plurality of alternative sources and distributing approved diagnostic content on a web-based marketplace.

FIGS. 6C and 6D show a schematic diagram of an example system for storing externally developed techniques for analysis, vetting material, and distributing approved content on a web-based marketplace.

FIG. 6E is a schematic diagram of an example system for publishing anonymized datasets to a web-based marketplace.

FIG. 7 is a schematic diagram of an example system and process for selection of individuals to participate in a business initiative based on a process using a/b testing to determine expertise on information for the purpose of planning and segmenting participants.

FIG. 8 is a schematic diagram of an example prediction engine used in predicting outcomes from separate business problems.

FIG. 9 is a schematic diagram illustrating an example system used for aggregating business data and automatically publishing content to specified users.

FIG. 10 is a schematic diagram of an example system used based on a decision engine for automatically generating diagnostic queries for business problems and then refining the automatically generated apps.

FIG. 10A is a schematic diagram of the engine used to generate automated queries, in accordance with aspects of the present invention.

FIG. 10B is an example schematic diagram of the engine used to automatically generate datasets defining solutioning teams to resolve business problems.

FIG. 11 a schematic diagram of an example system for collecting systems data into the interpretation and scoring logic system and aggregating the data and building it into the schema.

FIG. 12 is a schematic diagram of an example system used in a process for collecting assorted public (external) data and systematizing the information based on an interpretative scoring process and sequencing it into a logical framework.

FIG. 13 is a schematic diagram of an example system for generating specific population lists to be queried based on predetermined inputs that in turn generate an automatically selected population for sessions based on determinant algorithms and comparisons.

FIG. 14 is a schematic diagram illustrating an example system used for creating business solutioning ideas within the organization.

FIG. 15A is a schematic diagram of an example system for presenting output according to an alternative schema format based on a master schema.

FIG. 15B is a schematic diagram illustrating an example of a system from presenting translated content from alternative schemas into a format based on a master schema.

FIG. 16 is a schematic diagram of an example system for automatically recommending business conversations based on the data obtained from the holistic business diagnostics.

FIG. 17 is a schematic diagram of an example system that automates meetings.

FIG. 18 is a schematic diagram of an example system that monitors inputs to generate recommendations and report on changes.

FIG. 19 is a schematic diagram illustrating an example system used for matching consultant-generated solutions concerning specific enterprise related issues.

FIG. 20 is a schematic diagram illustrating an example system for using data inputs vetted through established protocols to determine bid decisions for contracts.

FIG. 21 is a schematic diagram illustrating an example system for measuring the financial model of an enterprise.

FIG. 22 is a schematic diagram illustrating an example system for automatically calibrating the predictive success from automatic interviews based on successes of previous candidates.

FIG. 23 is a schematic diagram illustrating an example process of automatically calibrating the automatic hiring determinant system based on successes of previous candidates.

FIG. 24 is a schematic diagram of the system used to process responses from automated interviews, in accordance with an aspect of the present invention.

FIG. 25 is a schematic diagram of the predictive engine used for auto-generating recommendations based on interface of external inputs and system signals according to a specified event, in accordance with aspects of the present invention.

FIG. 26 is a schematic diagram of the automated system for filtering and transforming information feeds from previously described engines into a dynamic visual display, in accordance with an aspect of the present invention.

FIG. 27 is a schematic diagram of an example engine used to interact with data integrated into a plurality of external systems.

FIG. 28 presents an example system diagram of various hardware components and other features, for use in accordance with aspects of the present invention;

FIG. 29 is a block diagram of various example system components, in accordance with aspects of the present invention.

### DETAILED DESCRIPTION

An aspect of the present invention provides a broad system for business optimization by presenting data according to a selected schema. The data presented according to the schema is generated by transforming data received into schema data according to a selected schema.

I. Core System Logic

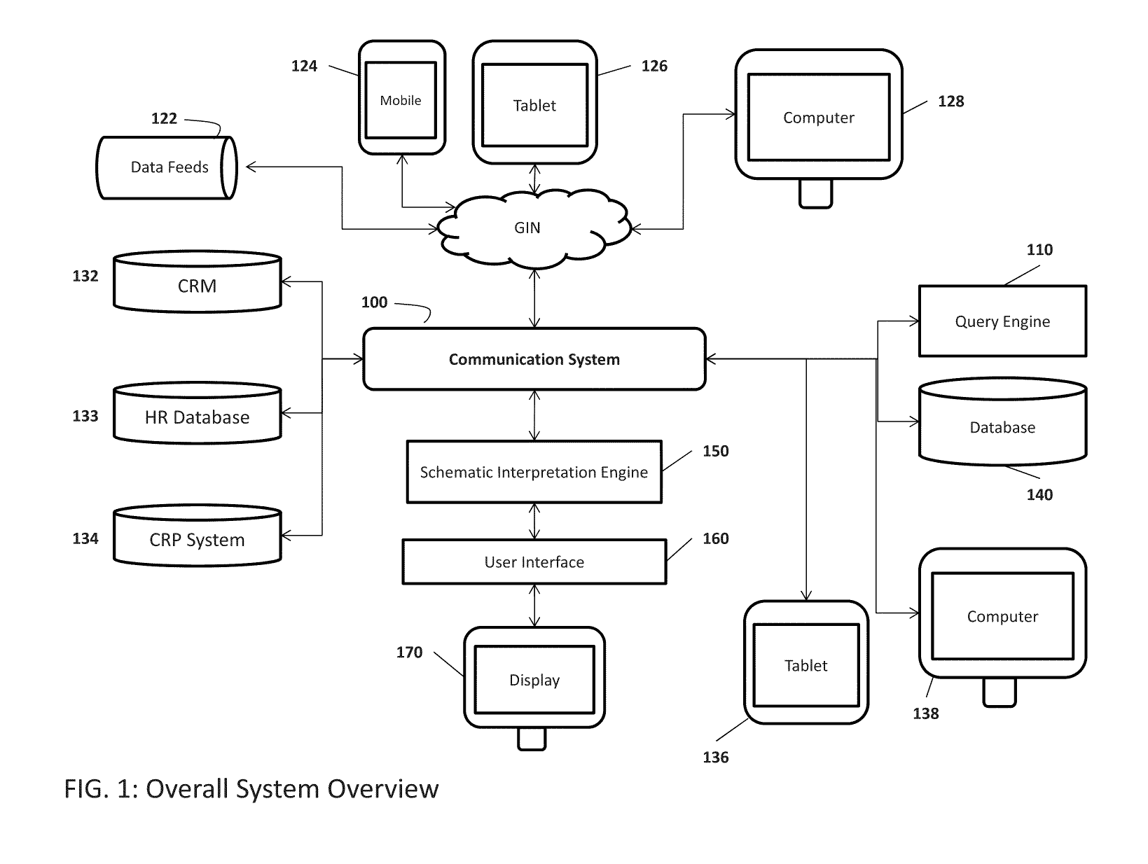

FIG. 1 is an overview of the system architecture. As shown, the system includes a communications system (interchangeably referred to herein as a communications sub-system) 100 for network communication with a plurality of data sources. A query engine 110 is connected to the communications system for requesting data from the data sources. The data sources include external data sources that communicate with the system through the Global Information Network (GIN) and internal data sources in direct communication with the system. Examples of external sources include data feeds 122 that provide market intelligence or other news and inputs from social media or outside sources made through communication devices such as mobile phones 124, tablet computers 126 and other computers 126. Examples of internal sources include the CRM system 132, HR Database 133, CRP System 134 as well as user inputs through computers such as tablets 136 and other computers 138. A database 140 stores data received from the data sources and a schematic interpretation engine 150 engine transforms data in the database 140 to master schema data according to a selected schema. The system may also include an engine for transforming the master schema data into data for alternative schemas and allows customized schemas. Various displays 170 may be used to display data in a format dictated by the selected schema. A user interface 160 allows a user to control the display. The hardware used to implement the system preferably includes at least one CPU with on board RAM; an input/output system bus (including control bus, address bus and data bus functionality); system memory; system storage (flash or hard drive); communications hardware for TCP/IP (or other protocol) based end-to-end connectivity and a wireless communication processor for enabling Wi-Fi, Bluetooth and/or other wireless data exchange over a local or global information network.

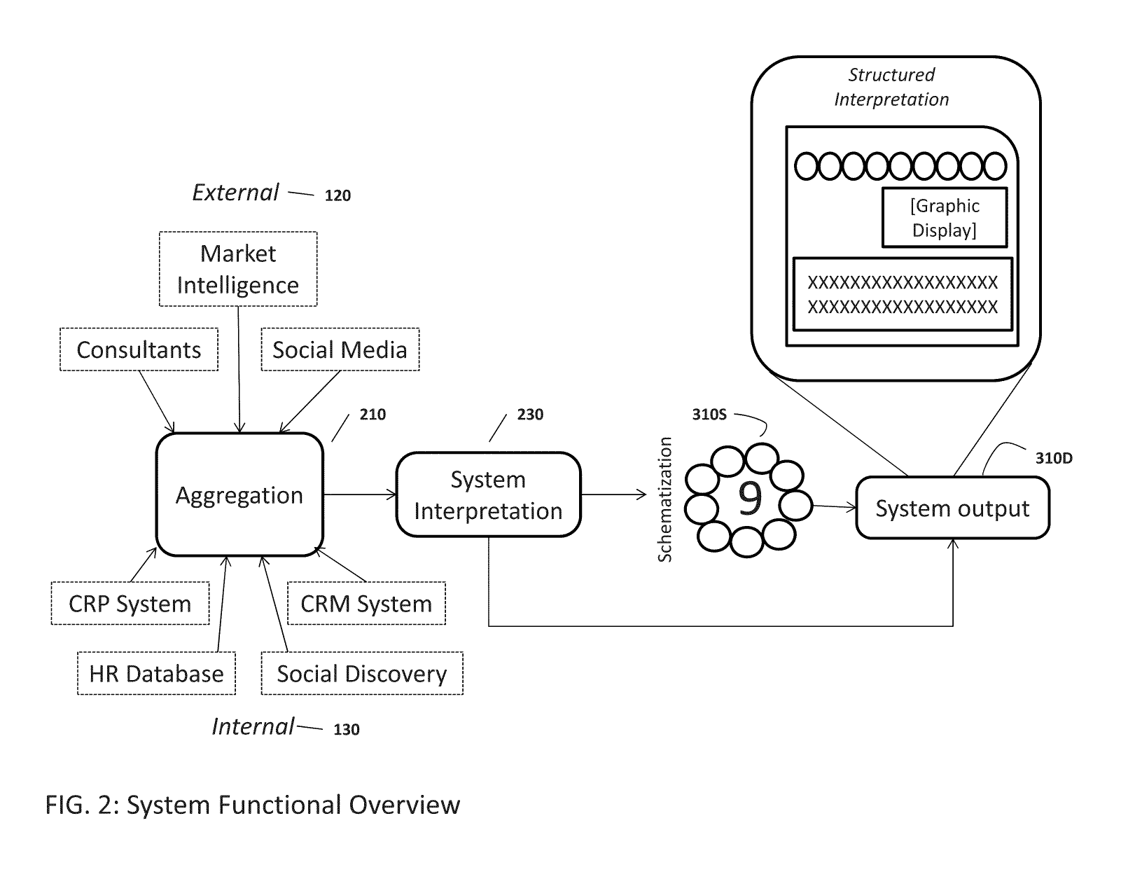

FIG. 2 shows a functional overview of the system. As shown, the data from External 120 and Internal 130 sources is aggregated 210 and passed to an interpretation engine 230 for transformation into schema data according to the selected schema 310S (in this example the 9Lenses schema). The data is then selectively displayed as system output 310D. The function of the invention is divided by two categories, (1) the fundamental logic of the system that drives the data collection, storage, transformation, and dissemination and (2) the extended uses of the systems logic in a plurality of subsystems.

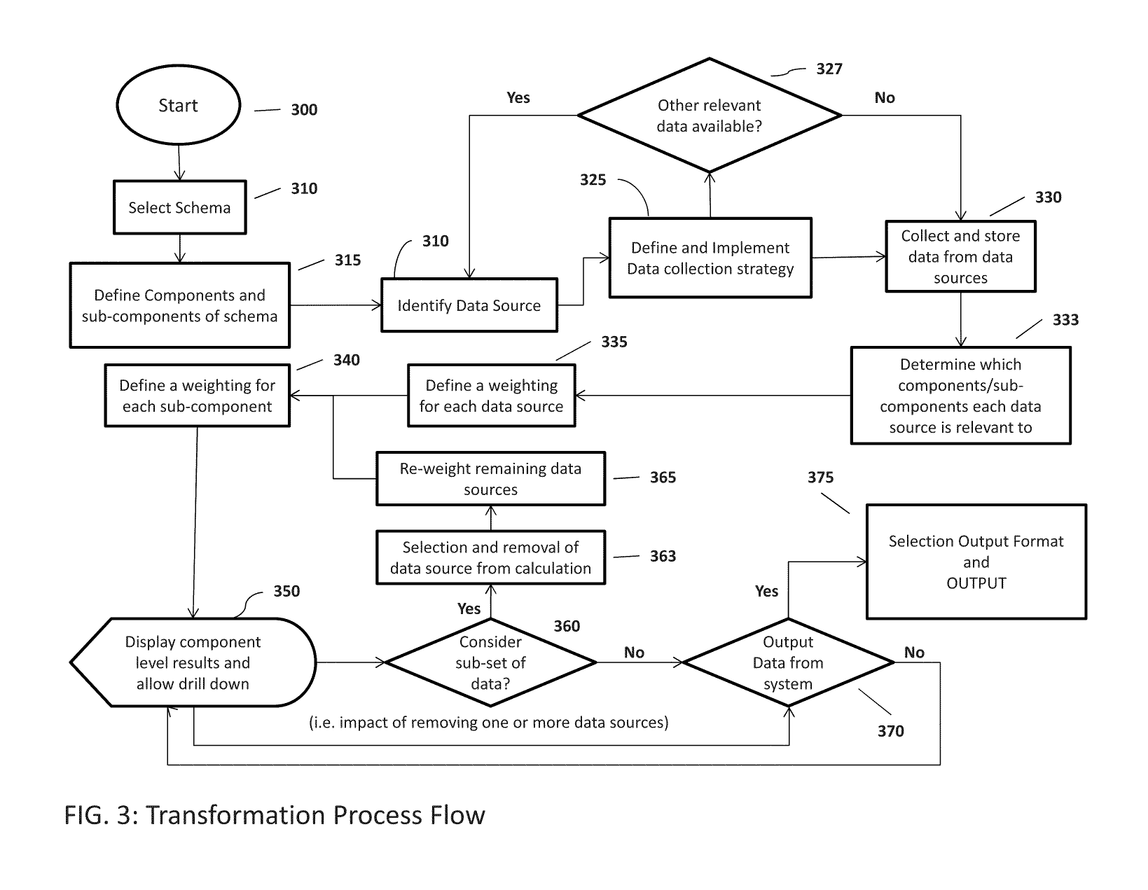

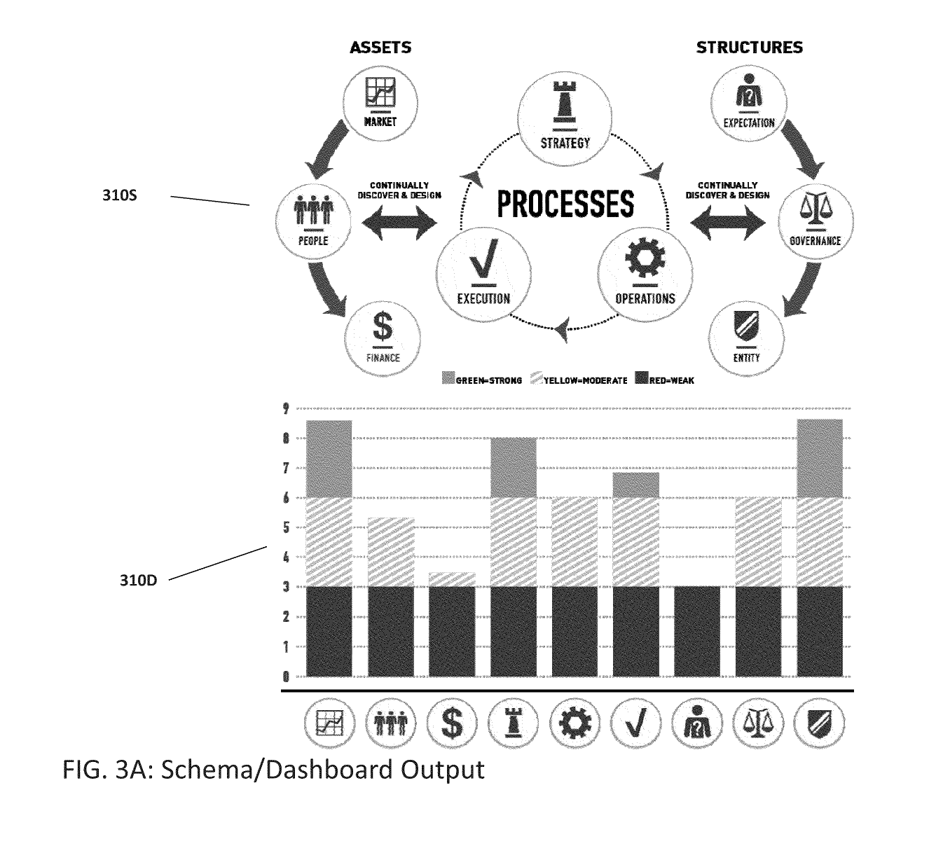

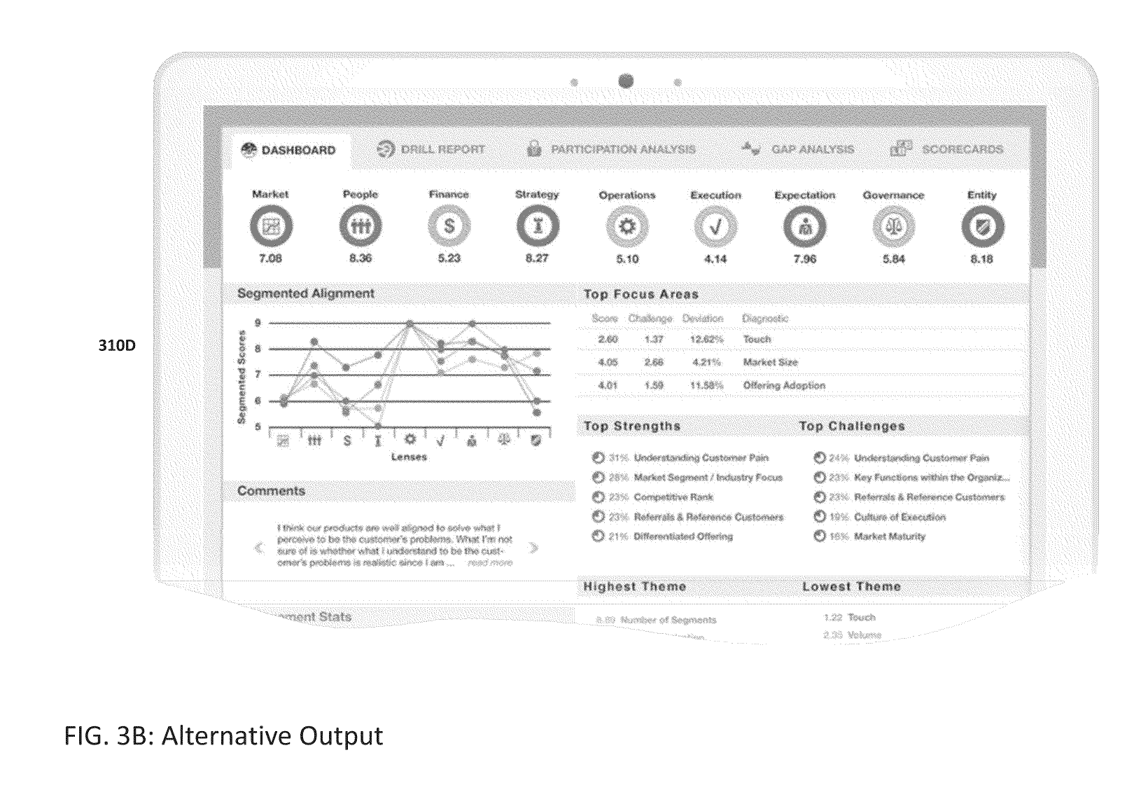

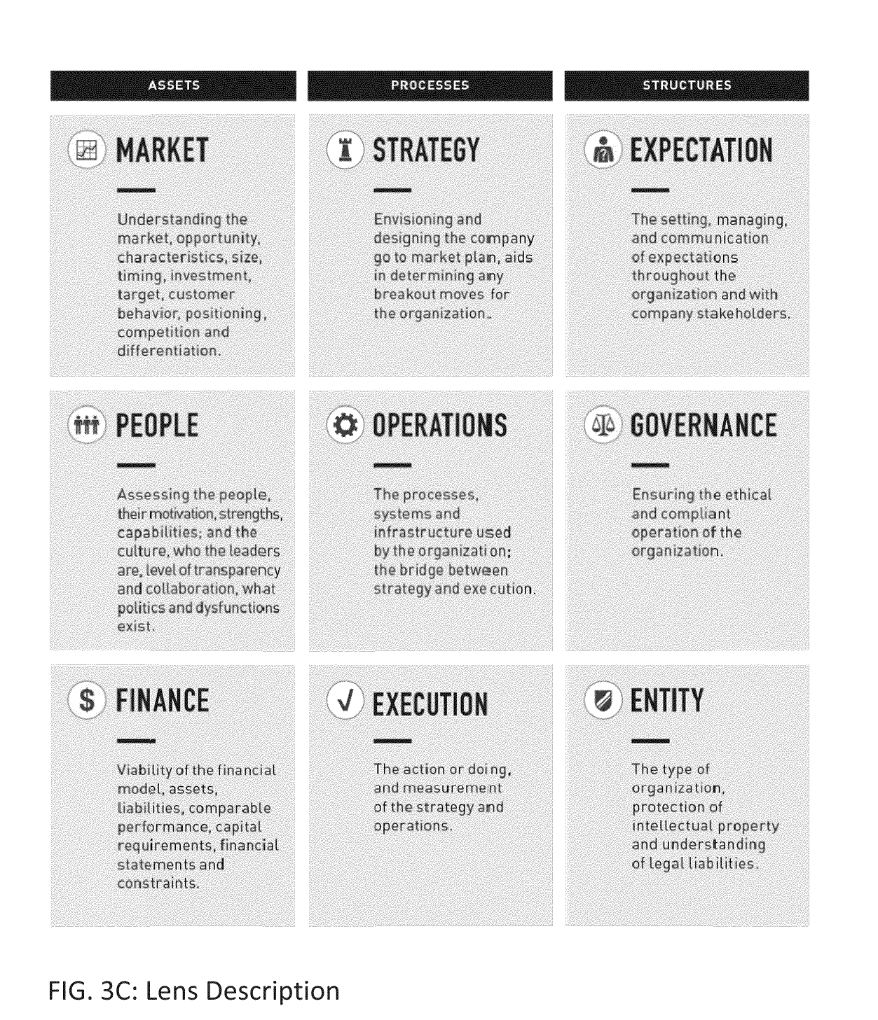

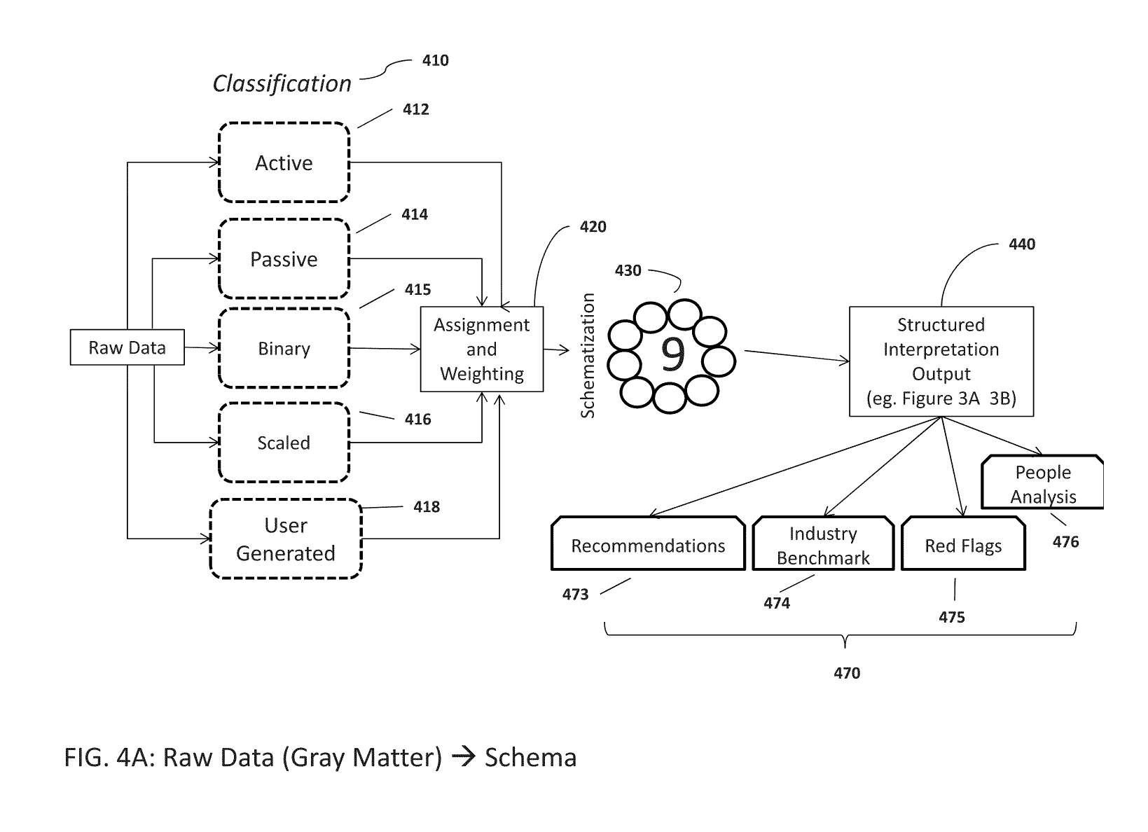

FIG. 3 shows the process flow for data transformation according to the invention. As shown, the process beginning at step 300 includes the step 310 of selecting a schema, which is described in greater detail below. At step 315, the components and sub-components of the selected schema are defined. The defined components (and their sub-components) are the characteristics of the enterprise that are to be evaluated according to the schema. A challenge arises in that there is rarely (if ever) a single data source within an enterprise that provides a complete measure of a component used according to an established schema. Thus, it becomes necessary to transform available data into data that provides the desired evaluation of a component according to the selected schema. At step 320, an available data source that is relevant to one or more of the schema components is identified. At step 325, a strategy for collecting the relevant data is designed and implemented and the relevant data is collected and stored at step 330. The process is repeated (step 327) so long as there are relevant data sources. At step 333, a determination is made as to which of the components or sub-components each data source is relevant to and at step 335 the importance of the data to a component/sub-component is defined by a weighting factor assigned to each data source. At step 340, a weighting factor is assigned to each subcomponent to reflect the relative importance of that sub-component to the component being measured. The weighting factors associated with data sources are preferable dynamically adjusted based on previous users responses from a particular participant and past performance. For example, the input of a particularly insightful data source (participant/respondent) may be given more weight, while a less insightful data source may be given less weight. A dynamic data weighing engine may be used for this purpose. At step 350, the system displays the component level results (as shown, for example, in FIGS. 3A and 3B) and the user is provided with the option (though user interface 160) to display the underlying constituent data, i.e., drill down to see the subcomponents and data that resulted in the overall result. At step 360 users are provided the option for considering specified sub-sets of the data (from step 333) apart from the aggregate data provided by the system. Users can select specific data from specified sources. At step 363, in response to the users' selections, the system removes one or more data sources from the calculation and reweights the remaining data sources 365. The system also provides the user with the option of outputting data from the system (at step 370) and allows the user to select an output format (step 375).

The step 310 of selecting a schema involves selecting an analytical structure for organized presentation of data that encompasses the assets, processes and structures that drive business success. By way of example, FIG. 3A shows the 9Lenses framework 310S and one example of an output display 310D of transformed data. In the 9Lenses schema, the components defined (step 315) are the 9Lenses (strategy, execution, operations, expectation, governance, entity, market, people and finance). The sub components are the “sub lenses” of the 9Lenses schema. FIG. 3B shows an alternative output that provides a more through overview of the data at the component level.

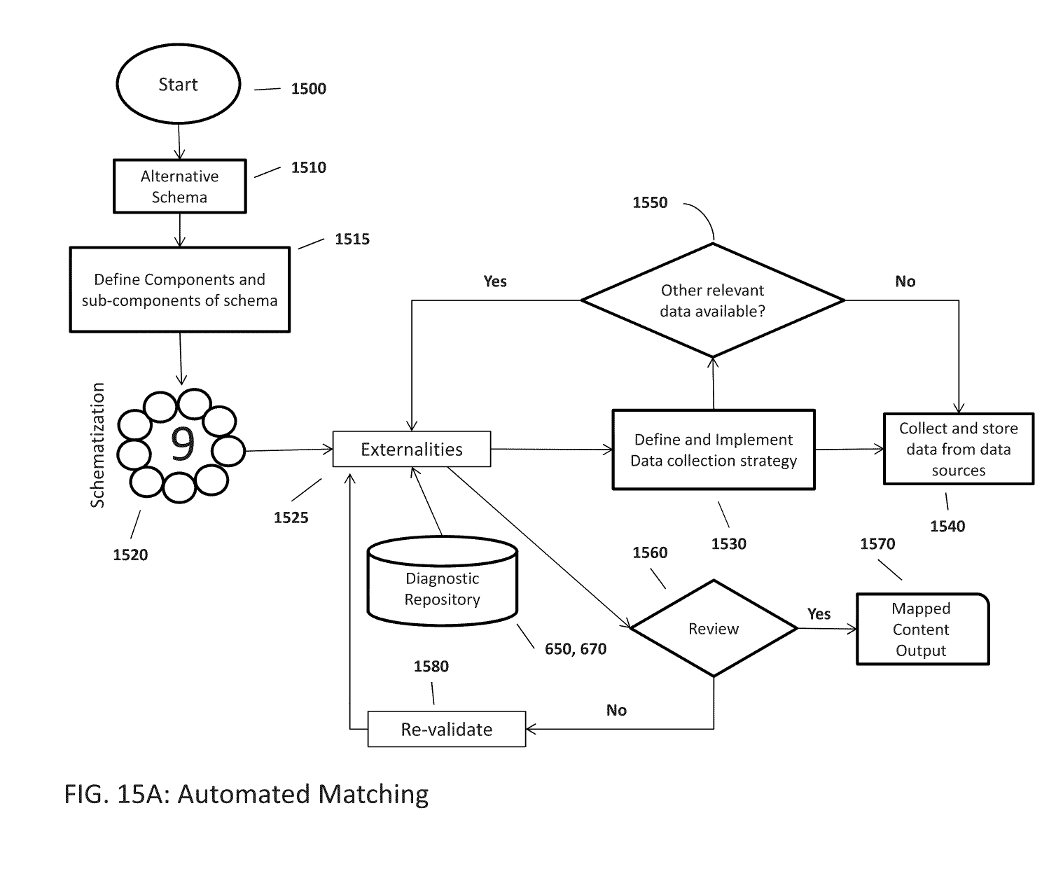

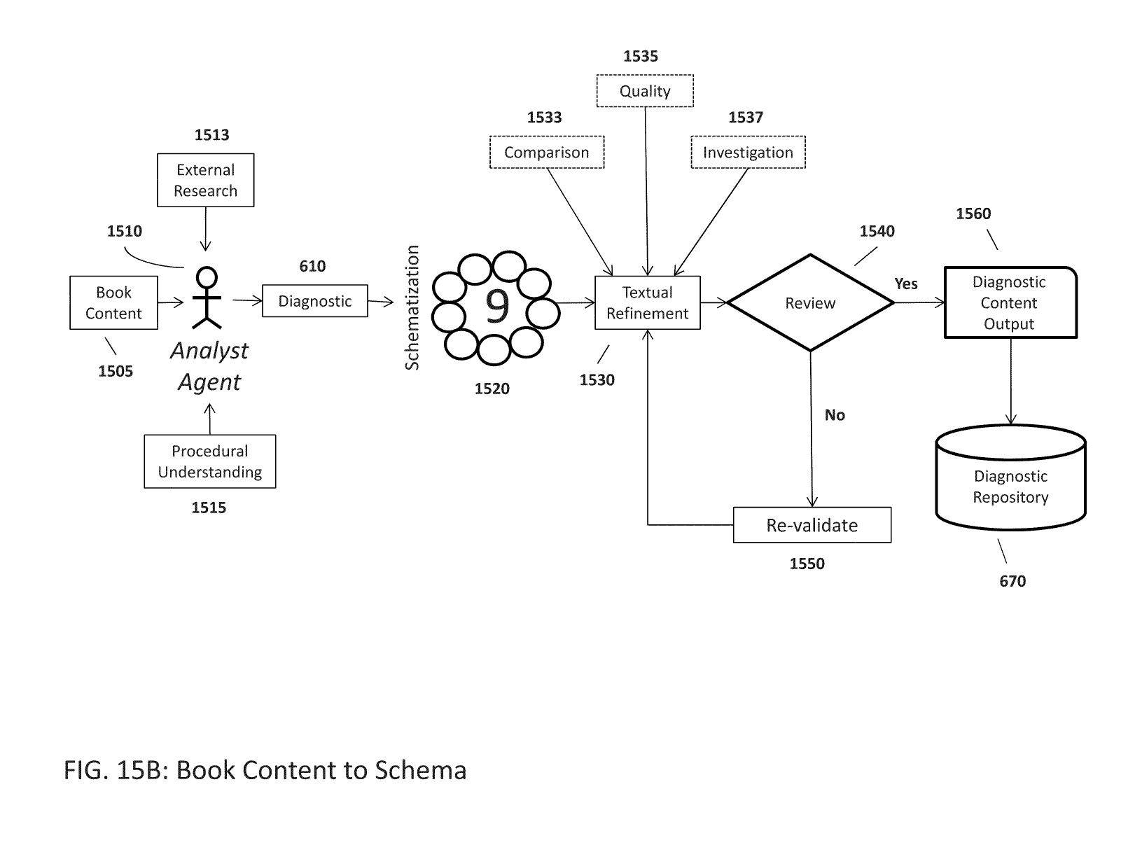

As shown and explained in FIG. 3C, the 9Lenses components provide insight into the assets, processes and structure within an enterprise. In this regard, the market, people and finance lenses may be grouped under the category “assets.” The strategy, operations and execution lenses may be grouped under the category “processes.” The expectation, governance and entity lenses may be grouped under the category “structures.” Other schemas typically use different labels for the different components and sub components used to provide insight into an enterprise. However, in accordance with an aspect of the invention, the component data for one schema (e.g., 9Lenses) may be transformed into and presented as component/sub-component data for another schema using a schema conversion process, one example of which is described in FIG. 15 below.

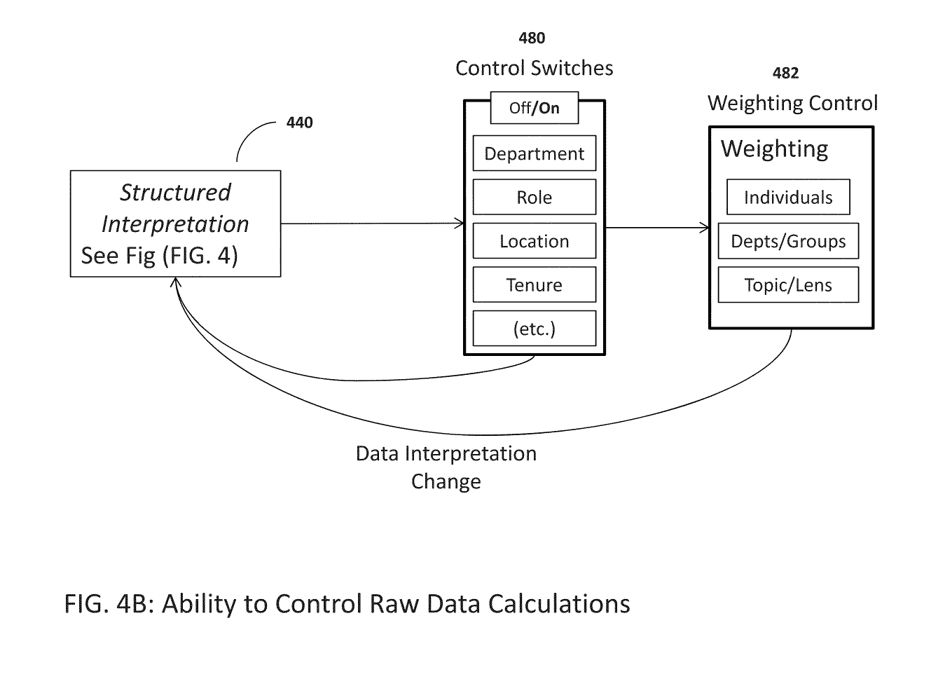

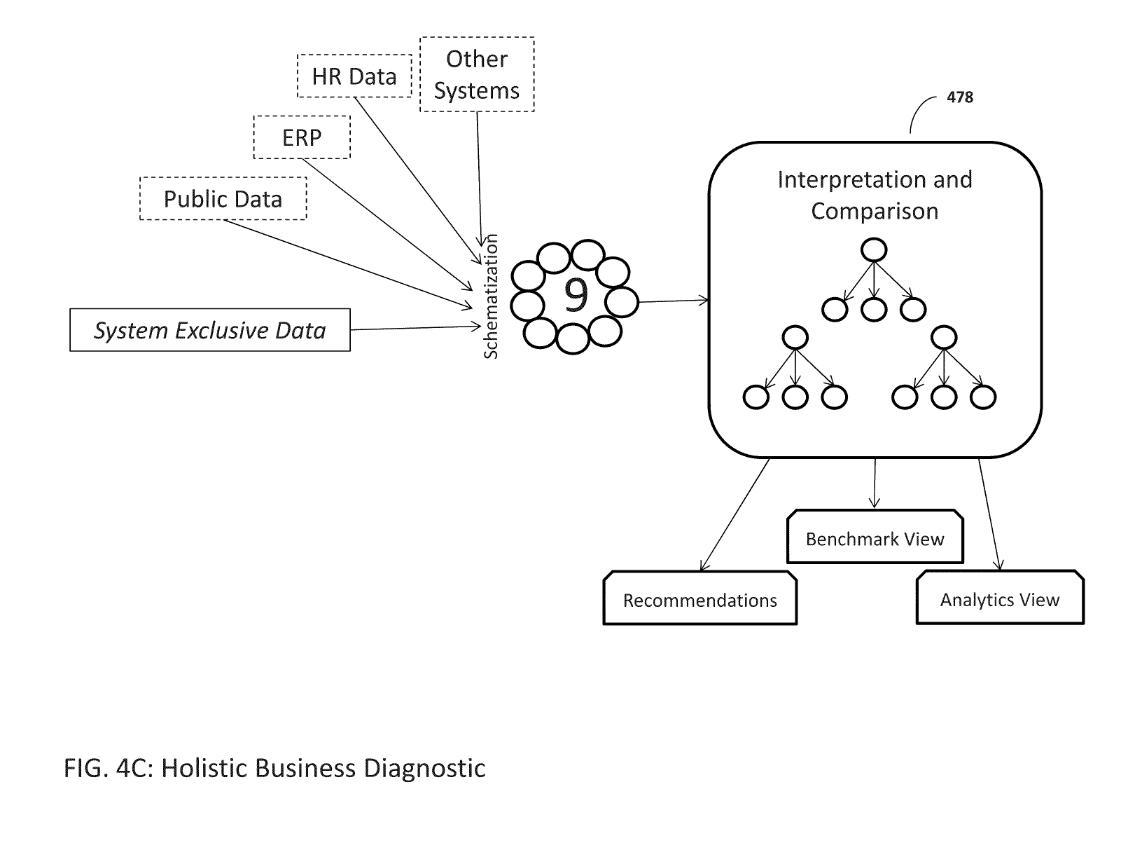

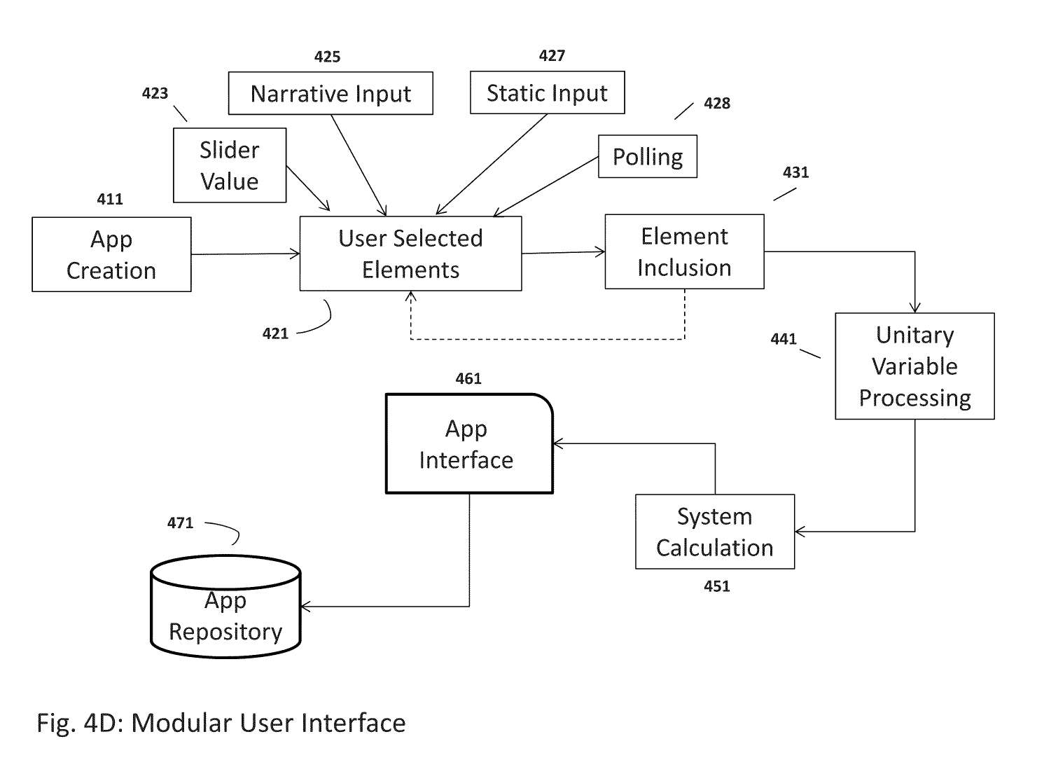

FIG. 4A shows the system used for transforming various inputs from raw data into usable information within the schema. Although FIG. 1 depicts the process at a high level as occurring in a schematic interpretation engine 150 that is in communication with other system components and the user interface 160, the process may occur at various locations based on various inputs. The process steps employed in the transformation of raw data into schema data comprise: collection of raw data; classification of raw data; assignment of data that has been classified; weighting of data and application of data to the schema components/sub-components.

As shown in FIG. 4A, the raw data that has been collected is classified (step 410) according to, for example, data type: active 412; passive 414; binary 415; scaled 416 and user generated 418. At step 420, the data is then assigned to one or more components/subcomponents of the schema and a weighting factor is determined for the data with respect to each component/subcomponent. The previous classification (412-418) is preferably a factor in determining the weighting assigned to data (step 420). At step 430, the transformed data is then applied to the selected schema. Preferably, the transformed data sources are each assigned to a subcomponent with a respective weighting factor and the subcomponents are given a weighting factor for their respective component. Once transformed data is applied to the schema and appropriately weighted, the system can output schema data in various forms according to user preference at step 440. For example, the data may be displayed in the “dashboard” format depicted in FIG. 3A or 3B or output to another program or application or a printable format.

As shown at 470 in FIG. 4A, the system may also use transformed schema data to generate and output action step guide outputs such as recommendations 473; industry benchmark comparisons 474; red flags 475 and people analysis 476. In this way, the system leverages the transformed data to provide additional tools in the form of reports and indicators based on more accurate and up to date data than would otherwise be available. For example, the industry benchmark feature allows comparison of an enterprise's performance to other enterprises in the industry. Importantly, the system allows such comparisons even among companies that select different schemas because of the ability to interpret data from other schemas.

FIG. 4B shows an aspect of the invention which allows the user to control, through the user interface 160, data input and weighting to permit segmentation and analysis of the degree of impact of departments or sectors and analysis according to one's own view as to the significance of particular business relevant data to business issues. As shown at 480, the system includes control switches to allow the user to enable and disable inputs used to generate the system output along the lines shown at 360 in FIG. 3. As shown in FIG. 3, when data inputs are disabled, the system reweights remaining data sources 365 and generates revised output. The system further includes a weighting control feature 482 that allows the user to override the default weighting in defining the weighting for a data source (step 335). The system generates revised output based on the new weighting so that the user can see the impact of the change in weighting.

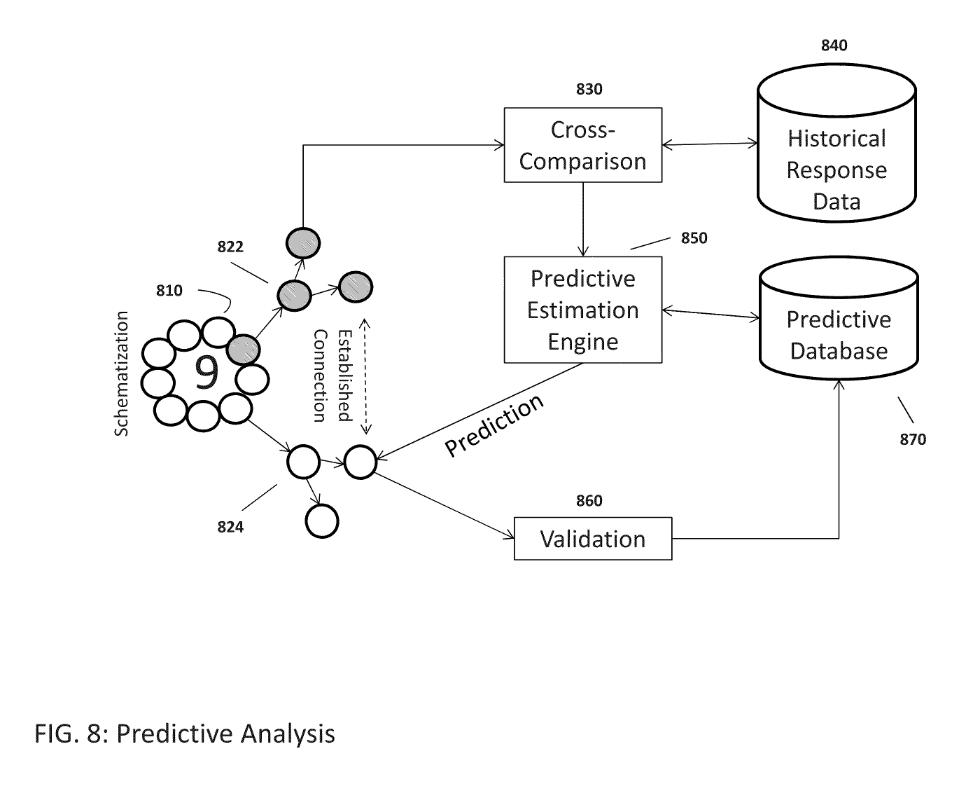

FIG. 4C shows the system used to measure various inputs and determine comparative analysis of the entire business operation. As shown, the system is similar to that of FIG. 4A and system exclusive data is depicted as distinct from public and or enterprise data that is used for purposes other than the system per se. System exclusive data is data that is, in the first instance, generated or collected expressly for the purpose of inputting into the system, e.g., responses to system queries. As shown, the system includes an interpretation and comparison engine 478 performs comparisons across data sets to provide additional views and recommendations based on the transformed data. An example, described below in connection with FIG. 8, is the predictive analysis of predicted outcomes of business problems.

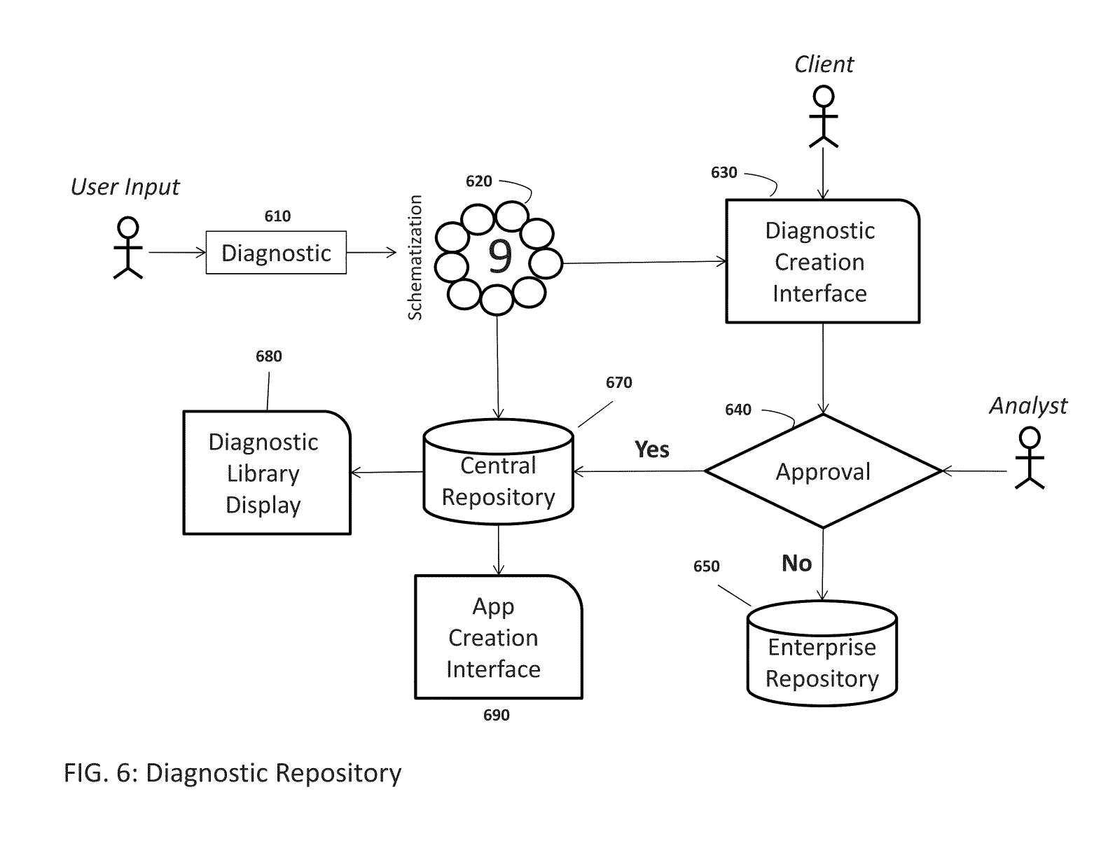

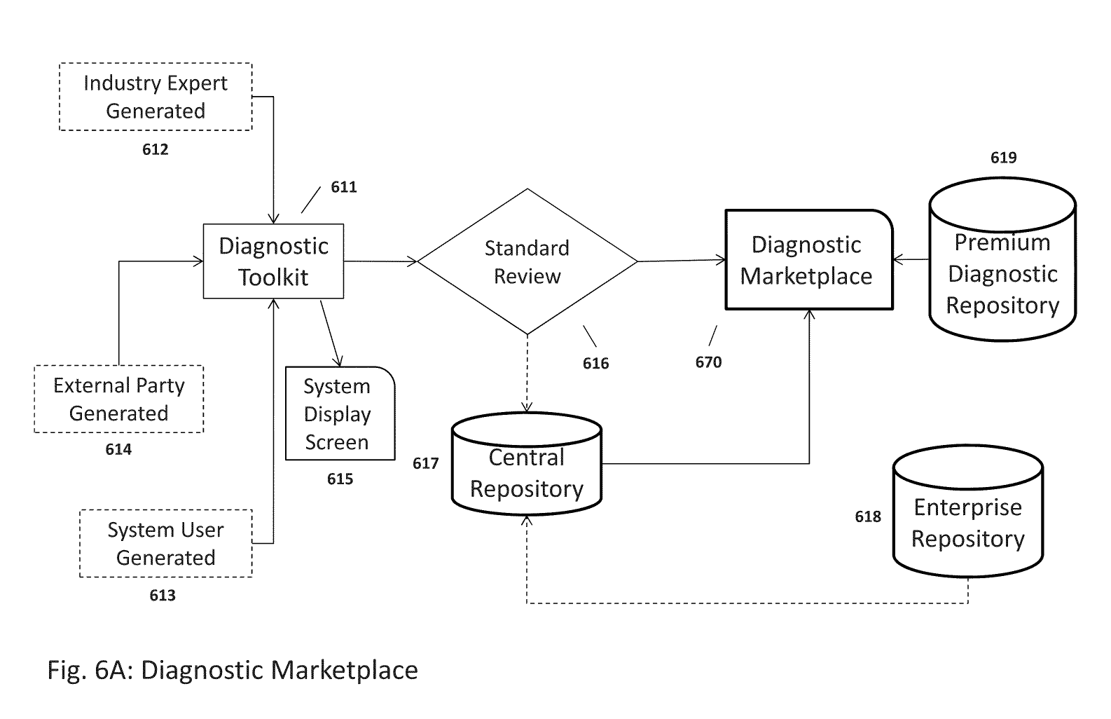

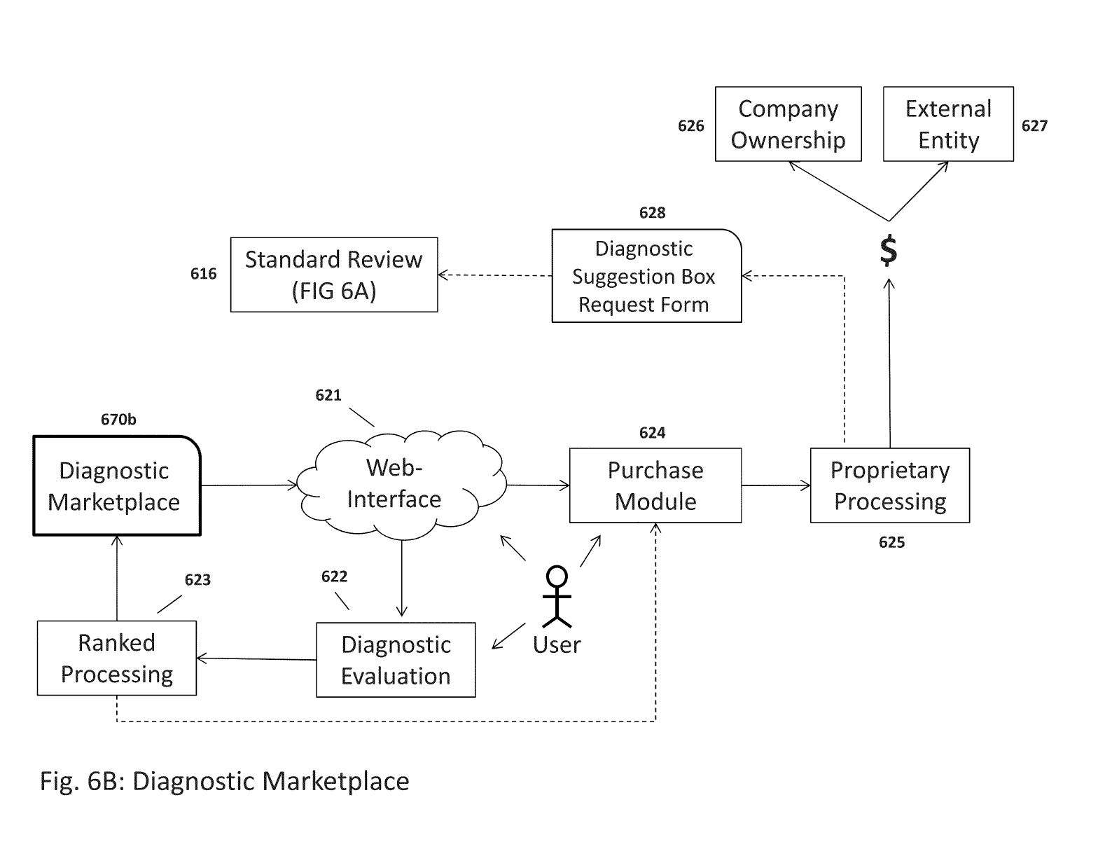

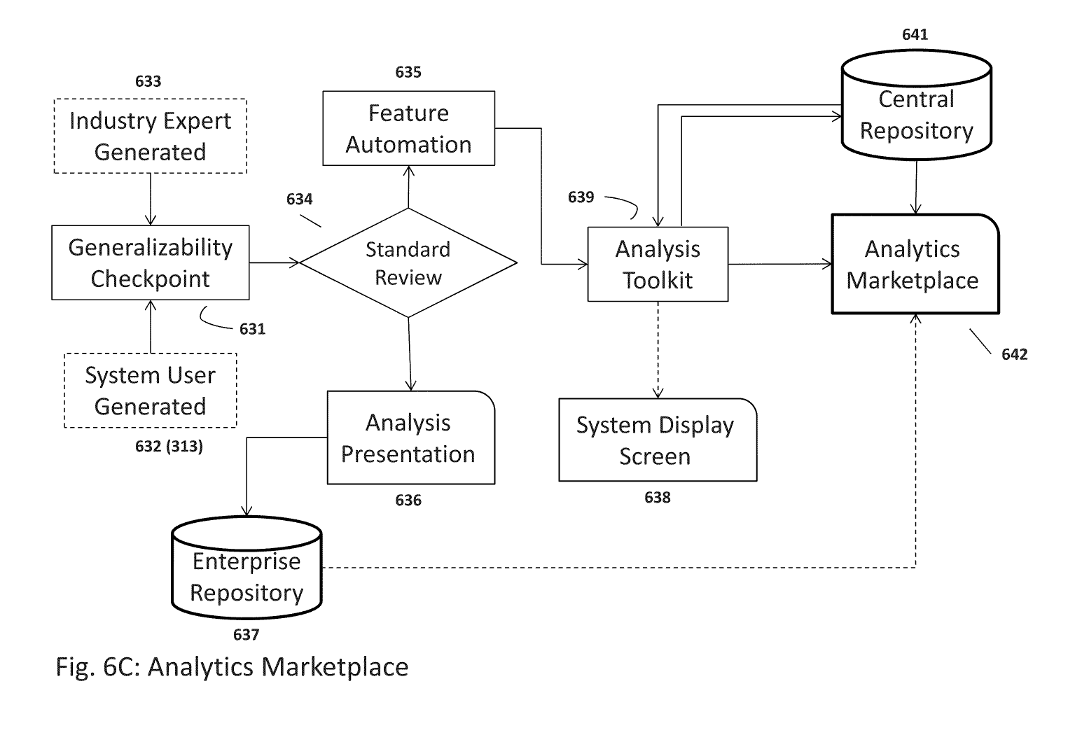

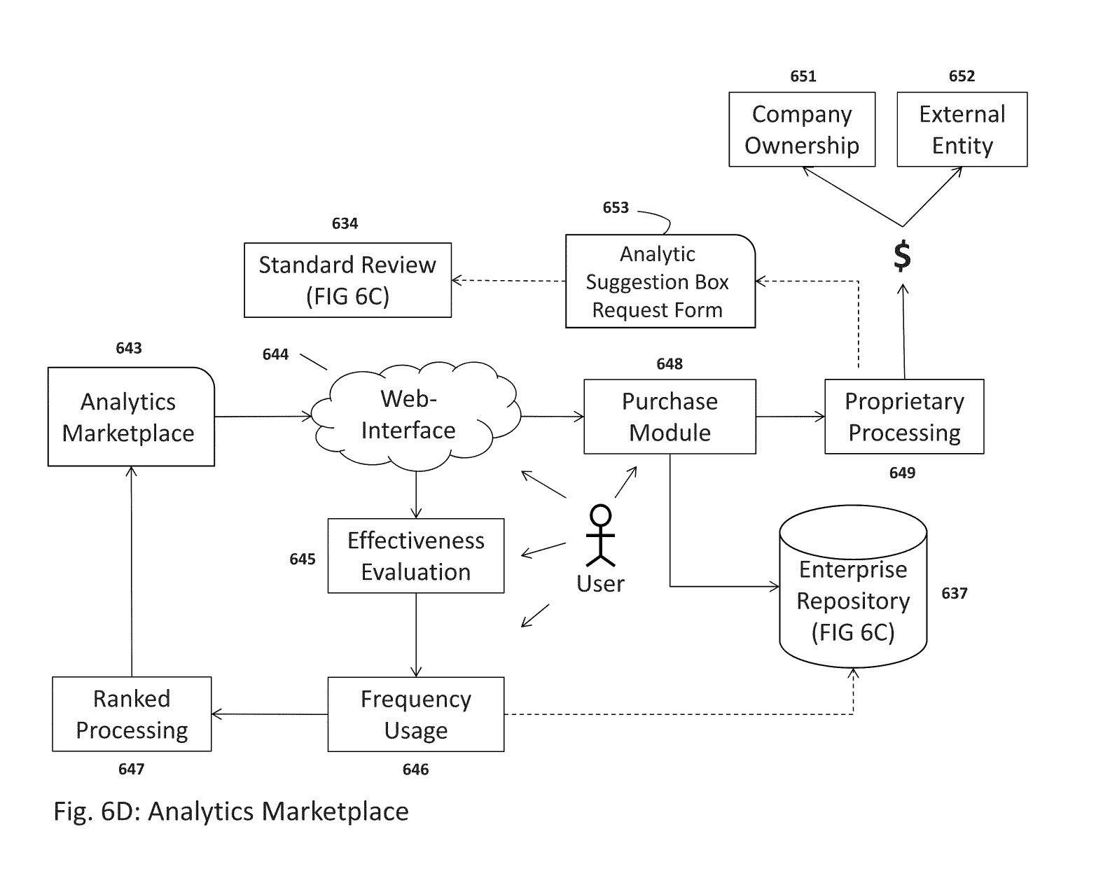

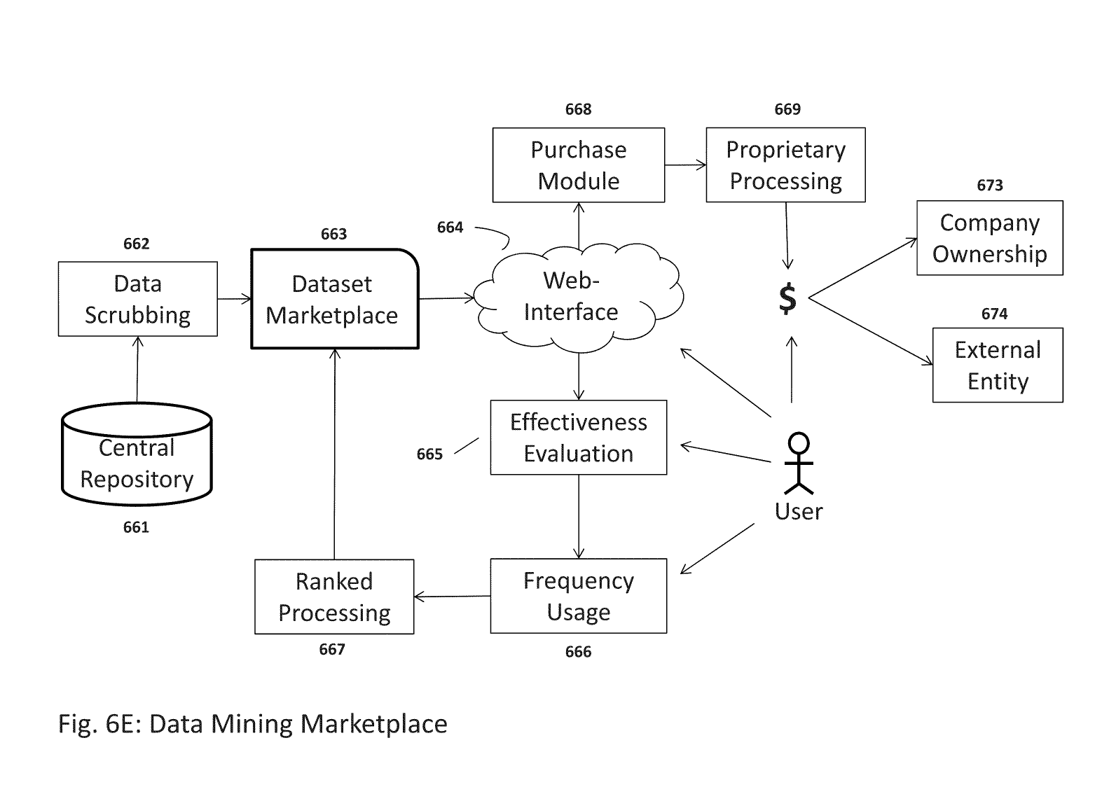

In addition to collecting user inputs as previously described, the system may further comprise an interface, as shown in FIG. 4D, for collecting alternative inputs from users. The alternative inputs are provided via an application creation module 411 where users may be presented with a plurality of inputs (i.e., 423, 425, 427, 428). Based on these inputs the users select particular inputs for each diagnostic 421. The system processes each of the user-selected elements for individual diagnostics 431 until every diagnostic has been finalized. Once the diagnostic set is finalized, the system orients the plurality of variables to provide unitary results 441 for filtered use in the analytics interface. At 451, the system calculates unitary values of the diagnostic set and the diagnostic set is then displayed in the application interface 461 for user selection. Modular diagnostics sets are stored in the application repository 471 where they can be used by other users within the same enterprise or vetted to the diagnostic marketplace (e.g., FIGS. 6C and 6D) as described in more detail below.

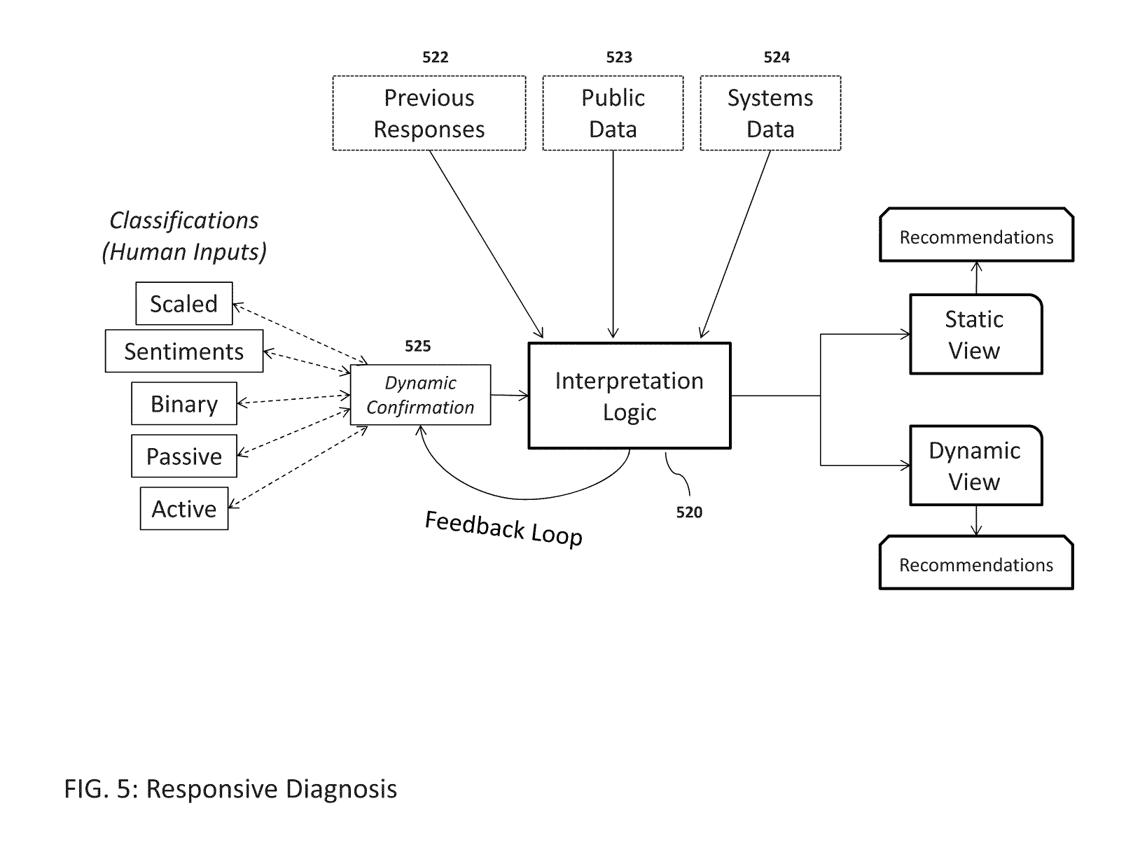

FIG. 5 shows the system used in a process for evaluating and confirming business data inputs based on interpretative logic grounded in dynamic feedback loops. By way of example, when data input is based on human input (e.g., response to a system query), the interpretation logic engine 520 evaluates the response against previous responses 522, public data 523 and systems data 524 to identify a possible inconsistency, incongruity or anything else that might indicate erroneous input or enterprise inconsistency. When a possible error is identified, the dynamic confirmation engine 525 seeks confirmation of the data input by, for example, sending a query to the data source. Information from the interpretation logic engine may be viewed as a single instance (static view) or as a dynamic view and the system generates recommendations to remedy the detected error or inconsistency in data input. This aspect of the invention is especially important in detecting instances where a single input source may have relevant information that is unknown to others and separating such instances from mere errors in input.

FIG. 6 shows the system used for systematic collection, organization, schematization, storage and use of queries designed to elicit data pertaining to business problems into a universal database. The system includes a diagnostic input 610 for receiving a new diagnostic query from a user or agent. The diagnostic is then schematized 620, i.e., a record is created as to which components/subcomponents of the schema the query is relevant to. In addition, a record may be created as to whether the query is enterprise (client) specific or generally applicable. If the query is enterprise specific, it is passed to a diagnostic creation interface where it is processed as an enterprise diagnostic for use in an enterprise application (interchangeably referred to herein as an app). The query is then evaluated (at step 640). The system may include an automated evaluation/approval engine used to evaluate and approve (or not) user created content such as apps, individual diagnostics, suites of apps, and analytics features. For example, the approval engine may be used at step 640 to evaluate diagnostics once created by users. The users creating content (diagnostics, apps, suites of apps, etc.) could the system operator on user or independent authors, publishers or consultants employ analyst. The feedback from the system has demonstrated the effective content has certain characteristics in, for example, word count, word content, app length, etc. Using the system feedback and comparative statistics rules may be created or refined to allow evaluation of new content according to a set of preferred practices. Based on the evaluation, a score is assigned to new content. The approval engine may reject any content not having sufficient predictive score and provide feedback to the content created to allow the creator to modify the content, which at the same time educates the creator on preferred best practices. Once approved and in use, the content is given an actual score and any significant differences between the predicted score and the actual score are evaluated to provide feedback that may be used to modify/adjust the best practices. The approval engine provides agent-created apps with a percent ranking based on the established comparative statistics. Once the app receives a sufficient predictive score, the app is released to the central repository 670. If agents elect to release the app without a sufficient predictive score the app is vented to the enterprise repository 650, which stores apps generalizable only to the exclusive enterprise and not visible to other enterprises. Queries stored in the Central Repository 670 may be displayed by the diagnostic library display 680 and also used to create apps using the app creation interface 690. In this way, the system permits intake of individual diagnostics that are then transformed into queries that elicit interrelated information based on a logical framework for compilation into business diagnostics. The individual diagnostics may be transformed into apps (using the app creation interface 690) for the purpose of assessing business problems.

The system may further provide a virtual store, e.g., Diagnostic Marketplace, for exchanging diagnostics between a plurality of entities. For example, a user may use the virtual store to purchase diagnostics created by a user from a separate enterprise. As shown in FIGS. 6A and 6B the system gathers a plurality of dynamic inputs from external sources (612, 613, 614) and deposits the content into the diagnostic toolkit 611. The diagnostic toolkit displays the availability of such inputs 615 according to established organizational hierarchies determined by origin of the dynamic inputs (e.g. all inputs originating for a single department, single role, or single person). Inputs from the diagnostic toolkit are reviewed 616 according to established quality standards procedures. Vetted inputs are stored in the central repository 617. The central repository, in addition to the vetted inputs from 616 also contains stored diagnostics from the enterprise repository 618 from previously generated diagnostics that are sourced from the same classified entity. Inputs are transmitted from the central repository 617 and the premium diagnostic repository 619 to the diagnostic marketplace 670.

The system collates the plurality of inputs, which then interprets these signals and transmits them to the diagnostic marketplace as shown in FIG. 6A at 670a. The diagnostic marketplace interfaces with system users as shown in FIG. 6B at 670b through a global information network (e.g., Internet) 621 via user selections of options. The user is able to select specified diagnostics through the purchasing module 624. In addition to the interactions with 624, users may input their subjective evaluations of the quality of diagnostics as shown at 622. The system then collates user signals 623 according to a plurality of variables. The variables, for example, include seniority, ranked agreement on previous sessions, entity selected weighting, and system participation weighting. Ranked diagnostics are assimilated into 670 wherein they are displayed to the user with a scaled quality rating. User interactions with 624 are processed 625 according to established legal requirements. Monies are divided accordingly to the company 626 or any respective external entities 627. As transactions are processed, users can automatically generate requests for specified inputs. The requests are vetted and processed through 628 in the same manner as the plurality of other inputs from 616 with the information stored for internal review.

Similarly, the system may further provide a virtual store (e.g., Analytics Marketplace) for exchanging analytics features between a plurality of entities. For example, a user could purchase a deployed metric for predicting financial outcomes developed by separate enterprise. As shown in FIGS. 6C and 6D, the example system stores externally developed techniques for analysis, vetting material, and distributing approved content on a web-based marketplace. The system gathers inputs from external sources 633 and 632. Whereas with the example system diagramed in FIGS. 6A and 6B, the inputs were directly transmitted to the specified toolkit, the variation of this specific system shown in FIGS. 6C and 6D collects features according to their generalizable use across a plurality of analytical iterations 631 (e.g. application of predictive performance metrics to other teams). Once the system establishes the generalizability of the techniques, the inputs are transmitted to the standard review 634 wherein the information is automatically evaluated by predetermined standards. Based on the review of the dynamic inputs, the systematized information is either processed to automate the feature for future use 646 or transmitted to automatically generated, single-use presentations of the outputs 636. Individual presentations are stored in an enterprise repository as shown at 637 with separate outputs classified as enterprise-specific techniques of analysis. Alternatively, inputs that are selected for automation are integrated into the system features processing 635. Automated features are filtered into the analysis toolkit 639. In addition to newly automated analysis features, 639 also processes analysis features that have been previously stored in the central repository 641. New features are also assimilated into the central repository accessible through the entire systems. Users can see the particular components of the new analysis features at the system display screen 638. The analytics marketplace collects the newly created features from the analysis toolkit 639 and 641 and sorts them by groupings of analysis feature types automatically determined according to classification flags established by the system.

From the analytics marketplace as shown in FIG. 6D, the variation of the system transmits available features to a web-interface 644 wherein users can select particular features for purchase. In addition to selection for purchase, the system prompts the users to evaluate 645 the usefulness and effectiveness of individual features selected. The system also prompts users to estimate the frequency of usages for particular features 646. User estimations are forwarded to enterprise repository 637 for comparison between estimations and actual frequency of usage. The system collects respective rankings for a plurality of users to generate a dynamic ranking 647 from the existing ratings that is displayed accordingly at 643. As additional users evaluate specific features, the system collects these inputs and automatically corrects the dynamic ranking of the features within 643.

The system processes user selected analytics features through a purchasing module 648 to transmit the respective analysis features to the users enterprise repository. Transactions are processed 649 according to previously established arrangements between the company and the content creators of the app. Monies are divided accordingly to the company 651 or any respective external entities 652. As transactions are processed, users can automatically generate requests for specified inputs of analytics features. The requests are vetted and processed through 628 in the same manner as the plurality of other inputs from 634.

The system may further comprise a virtual store for publishing anonymized datasets to a web-based marketplace. According to an aspect of the present invention, this engine may, for example, access to stored proprietary data that mentions enterprise-protected data but would be useful for wider use such as research into industry trends. The system provides accessible data for research purchases without compromising propriety protections. As shown in FIG. 6E, the system stores individual datasets from distinct enterprise in a data repository 661. The data is sanitized 662 according to established practices for removing selective, enterprise-sensitive elements of the data. Once the data is properly vetted, the data is transmitted to the dataset marketplace 663 wherein users are able to purchase exclusive access to individual datasets through a web interface 664 via user selection of options through the purchasing module 670. In addition to the interactions with 664, users provide inputs on their subjective evaluations of the quality of individual datasets 665. Inputs are processed according to the standard types of ratings with the addition of frequent usage of the data 666 included. These ratings are collated 667 by the system and assimilated into 663 wherein they are displayed to the user with a scaled quality rating. Once the user has selected the dataset for purchase, they are granted access within the system to the anonymized data set. Payment is processed accordingly through propriety processing 669 and divided between the company 673 and any respective external entities 674. An alternative use of the virtual store allows for publication of anonymized data sets as business case studies for the purpose of educational use. Once an external agent approves specific datasets for use, the dataset is published to a pre-defined format for either partial, or full segments of the data set. Access is granted according to the same procedure defined at step 669 except payment is substituted for access granted determined by enterprise arrangements.

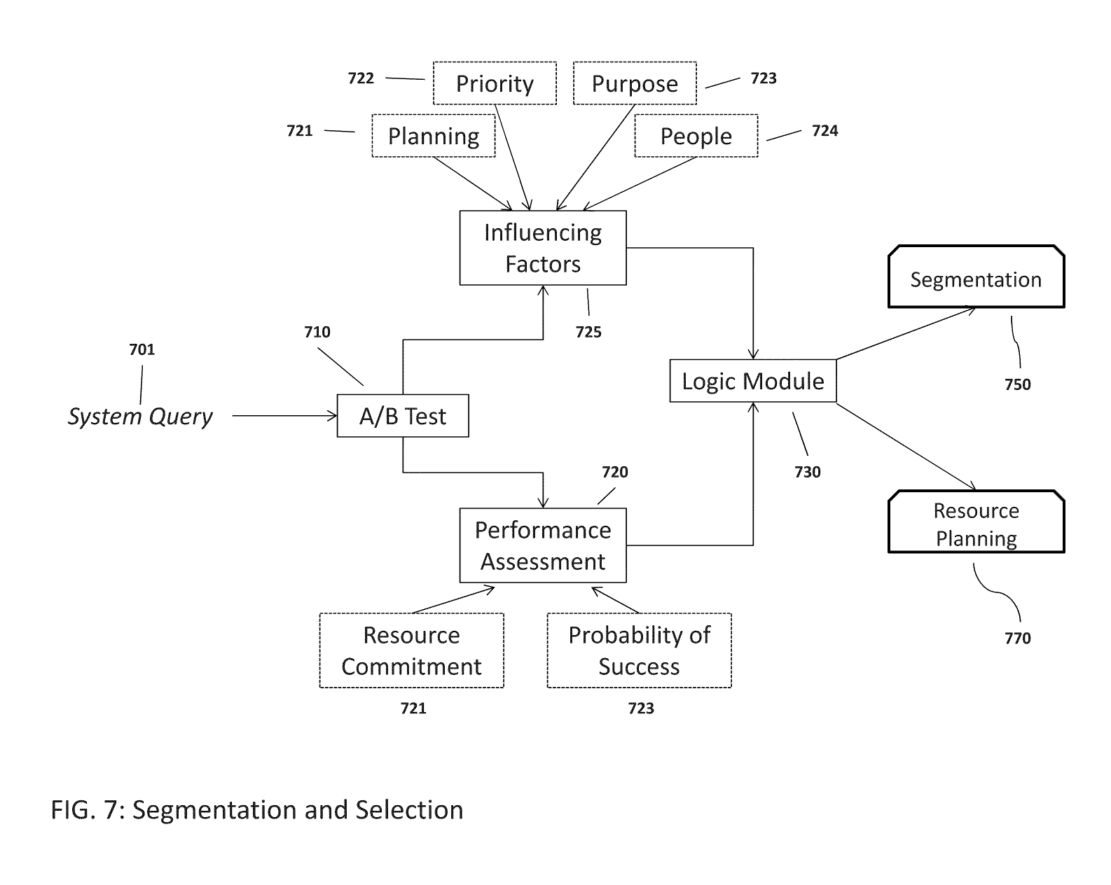

By virtue of the transformation and organization of data according to a schema, stored data may be used for other purposes. For example, FIG. 7 is a schematic diagram of an example system and process for selection of individuals to participate in a business initiative based on a process using a/b testing to determine expertise on information for the purpose of planning and segmenting participants. A shown, a system query 701 initiates the A/B test process 710. The A/B test process takes into both performance assessment 720 (based on desired resource commitment 721 and probability of success 723 given the desired resource commitment) and influencing factors 725 regarding the proposed app. A logic module 730 processes the inputs and outputs segmentation 750 and resource planning data 770. Segmentation 750 defines the role, organization, tenure or other characteristics of personnel suited for the task. Resource planning 770 outputs the availability of personnel and the enterprise impact of assigning available personnel.

FIG. 8 shows the prediction engine used in predicting outcomes from separate business problems. Predictive analysis begins with aggregated responses from schematized responses from participants 810. Based on predetermined connections, the prediction engine takes actual responses around specific components and sub-components 822 and predicts responses to other schema queries 824 that have established connections to the queries 822 for which actual responses have been received. As shown, a cross comparison engine 830 uses the actual responses 822 together with Historical Response Data 840 to provide inputs to a predictive estimation engine 850 that generates a prediction of the response to schema queries 824 that are known to have a predetermined relationship to the actual responses 822. Once the predicted responses to queries 824 have been generated, the system will prompt the user at 860 to validate the predicted response, e.g., confirm the predicted responses or provide new input. The results of the prediction are stored in the predictive database 870 and used as an input to refine future predictions by the predictive estimation engine 850. Preferably, the validation step 860 occurs as a separate user session to allow a more comprehensive response to specified business problems. In other words, the validation step is more than just a data input validation, but provides an opportunity to elicit important data used within the schema in a systematic way that is more efficient and focused because it is based on information already known to the system. The predictive analysis system of FIG. 8 thus acts as an intelligent agent to improve user input queries (at the validation step 860) though the use of predictive estimation.

II. Functional Extension of Core Logic

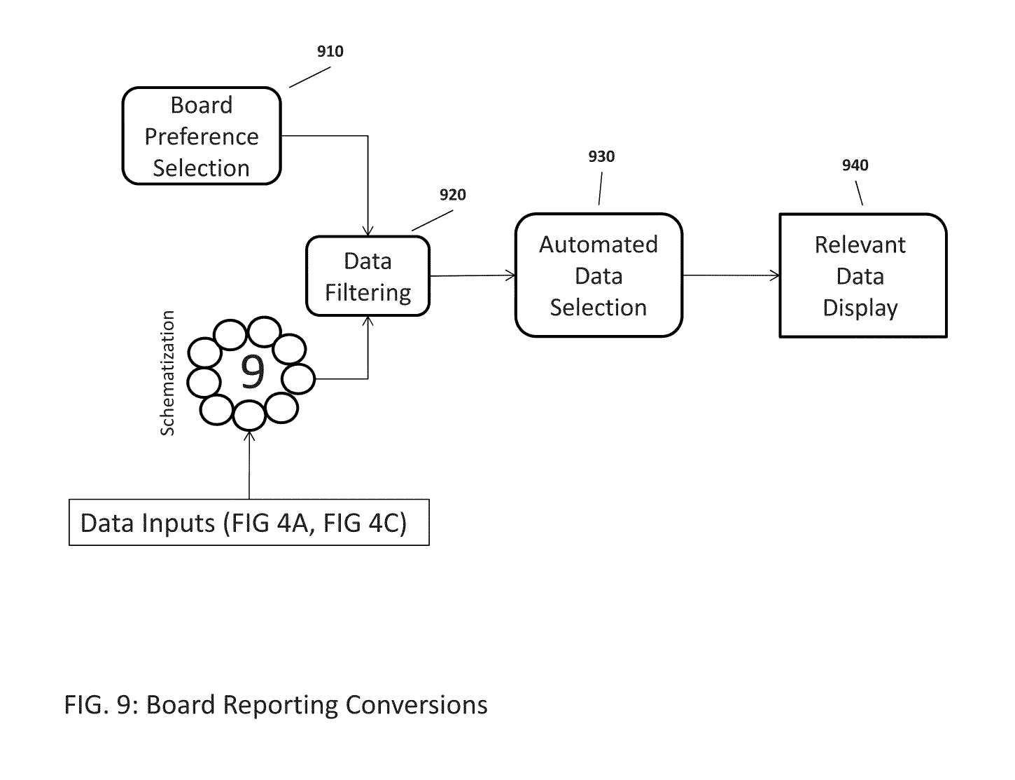

FIG. 9 shows the system used for aggregating business data and automatically publishing content to specified users, in this case enterprise board members. At step 910 a determination is made as to which subset of data will be provided to the user. The selection is input to a data-filtering engine 920, which flags the relevant data fields. The automated data selection engine 930 generates an automated Relevant Data report 940 periodically or whenever a threshold of new data in the flagged fields has been received.

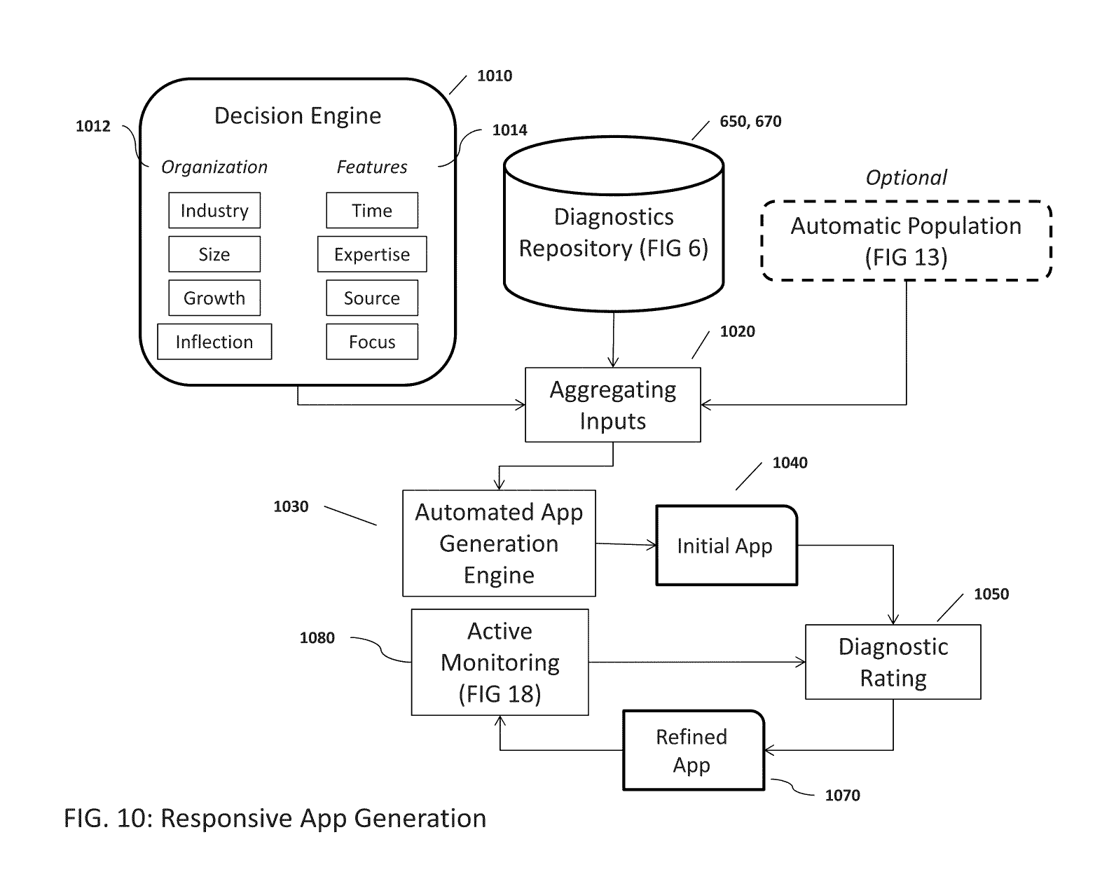

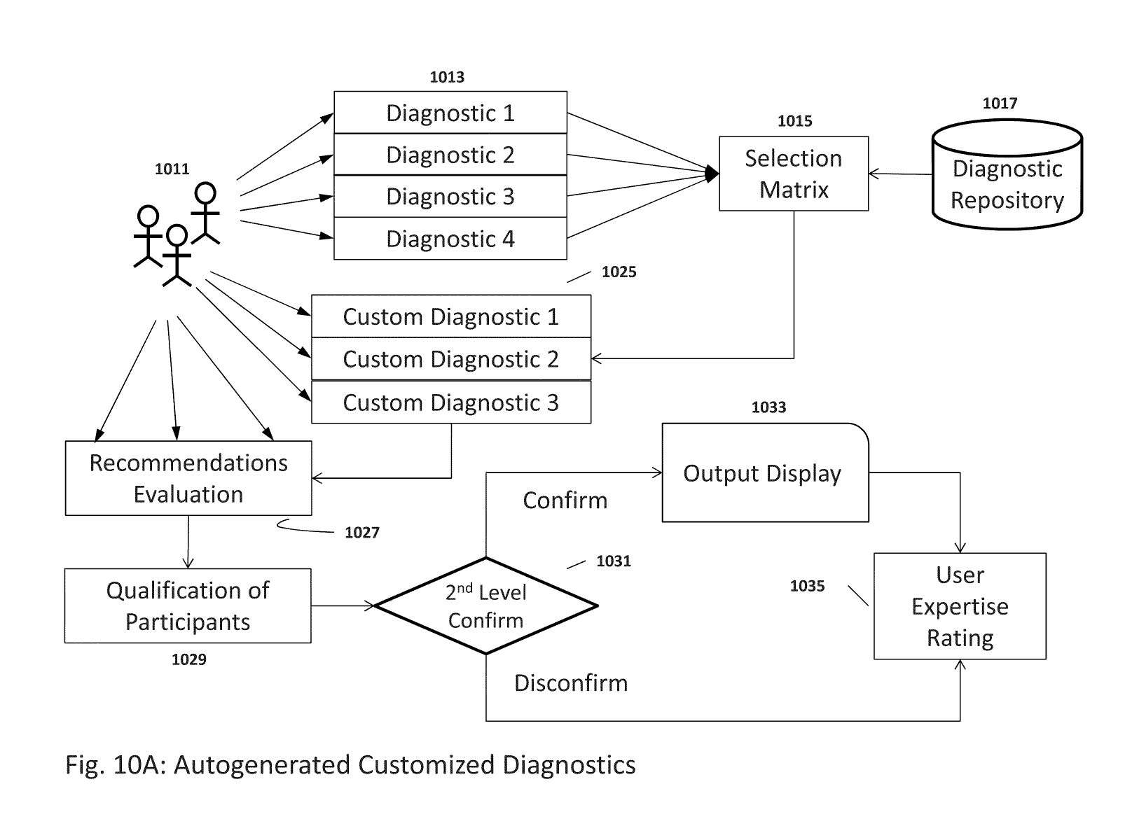

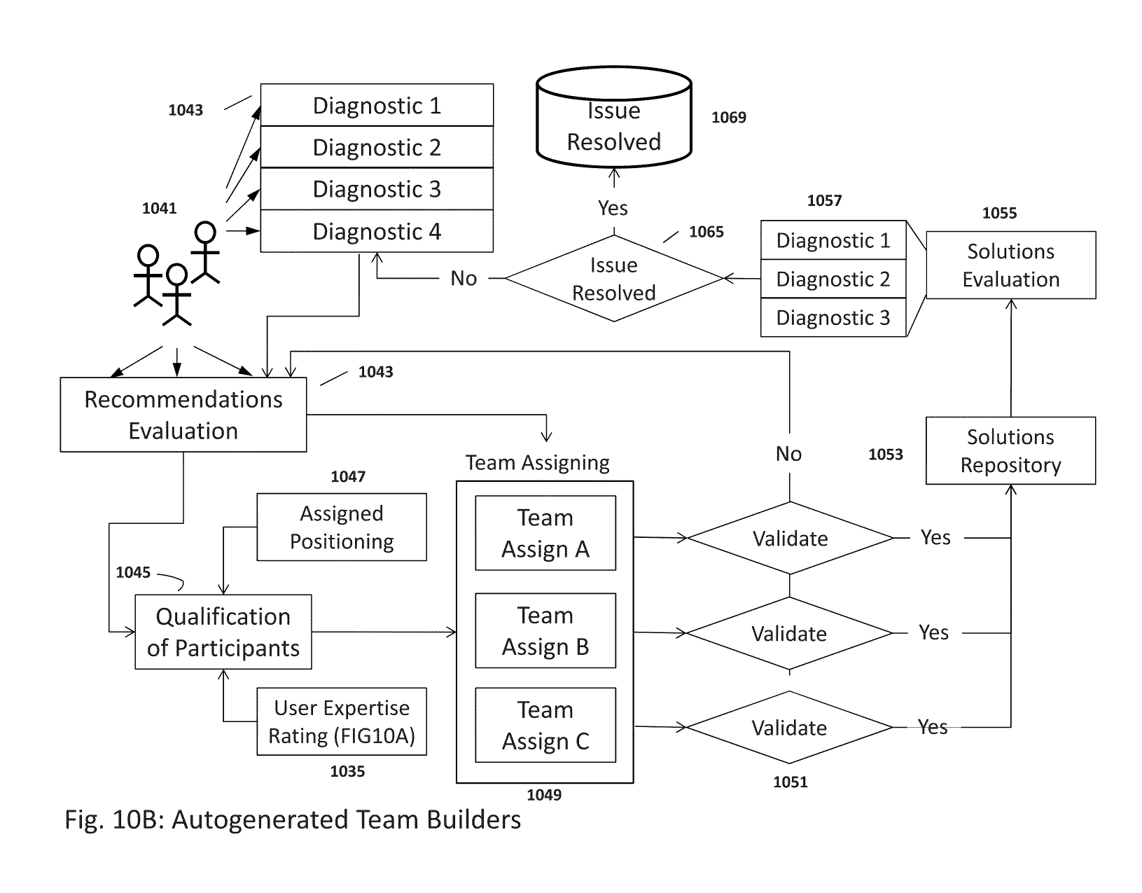

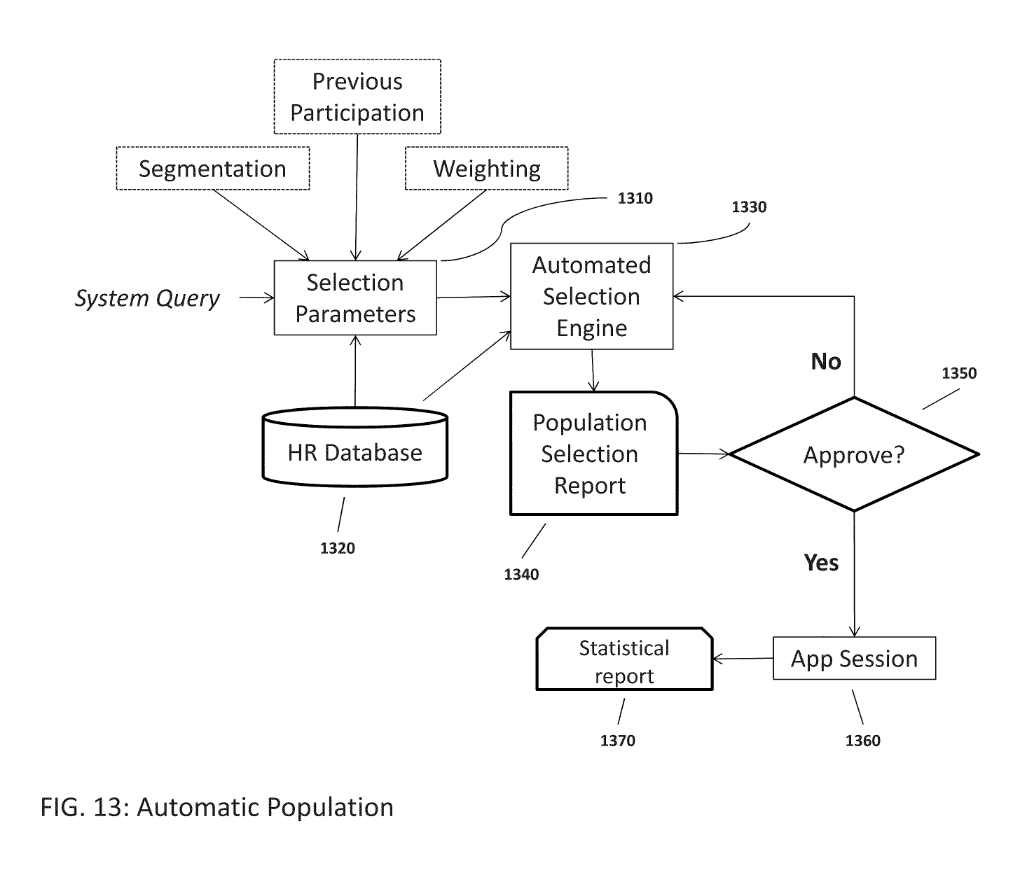

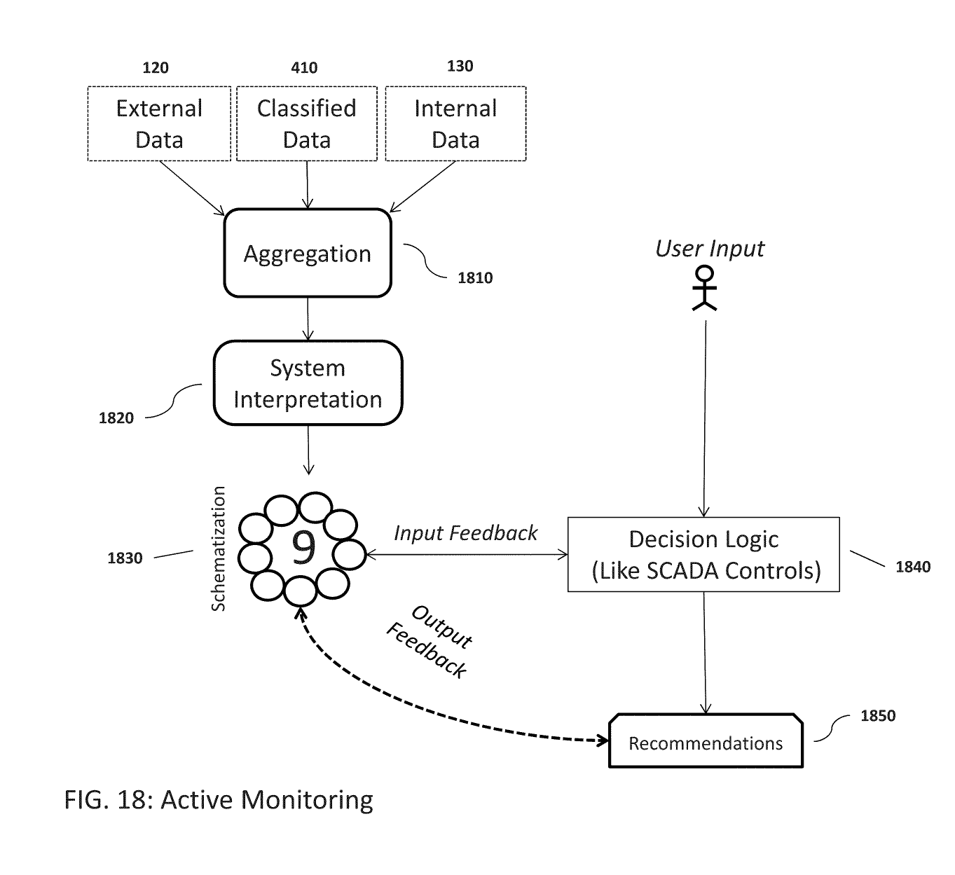

FIG. 10 shows the system used based on a decision engine for automatically generating diagnostic queries for business problems and then refining the automatically generated apps. As shown, the system includes a decision engine 1010 that allows priorities to be set according to enterprise organizational profile 1012 (industry, size, growth, inflection points) and preferences 1014 with respect to features such as time to completion, expertise required, source providing resources and area of focus (e.g. operations, execution etc.). The output of the decision engine 1010 together with the diagnostic library 650 and/or 670 and optionally the output of the automatic population engine of FIG. 13 are aggregated 1020 as inputs to an automated app generation engine 1030 that generates an automatically generated app 140 composed of diagnostic queries selected from the repositories 650, 670 based on the output of the decision engine 1010. The automatically generated app may then be evaluated by the user at the diagnostic rating step 150 preferably though a diagnostic-by-diagnostic assessment that results in a refined app 170. The refined app 170 is then subject to active monitoring (according to FIG. 18) to continuously refine the app 170.

The system may further comprise an engine for automatically generating a set of diagnostics based on predictive data from previous material. FIG. 10A shows an alternative form of app generation by dynamically generate diagnostic queries in a single real time experience for particular business needs such as a strategic offsite. An alternative aspect of this engine also allows for the individual query sets to be deployed in staggered sections. In either aspect, the engine queries a preset population 1011 with a predetermined set of queries 1013. The plurality of responses are collated and processed through an interpretive matrix 1015 that determines common trends and problems identified. Using the diagnostic repository 1017 the engine selects potential diagnostics matched against the inputs determined at 1015. The engine provides a second set of diagnostics 1025 based on a plurality of inputs such as words used, how they score, ranking as a training/communication gap, and responses of other users to also respond. In addition to collating scores and comments, the engine evaluates recommendation suggestions 450 by supplying 410 with a progressive rating for individual recommendations. The engine categorically ranks participant inputs 1029 according to qualified classifications such as seniority within the organization, use of particular wording, or agreement of system specific rankings. Based on these inputs the system confirms the validity of individual recommendations 1031 using a gradient rating scale with a minimal confirmation requirement. Individual recommendations passing the threshold are displayed in the session output 1033 according to identified issues matched with particularized recommendations. Individual recommendations that do not pass the gradient threshold are excluded from 1033. Respective results contribute to overall user experience ratings 1035. Individual recommendations rated highly on the gradient scale receive a positive improvement to their scaling level of experience. Individual recommendations rated poorly on the gradient scale receive negative scaling to their scaling level of experience.

The invention may further comprise an engine, as shown in FIG. 10B to automatically generate solutioning teams to resolve specified business problems. The engine queries a preset population 1041 with a predetermined set of queries 520. From the responses, the engine immediately filters the population-generated recommendations for evaluation 1043 by supplying the population 1041 with a progressive rating for individual recommendations. The recommendations are grouped according to determined categories for similar issues. The engine qualifies individuals from the respondent population according to qualified classifications such as seniority within the organization, use of particular wording, or agreement of strength/weakness votes. In addition to these system-determined qualifications, the engine also includes forced ranked assigned positions 1047 and the previously determined user expertise rating 1035. Based on the plurality of these inputs the engine automatically assigns individuals to respective teams 1049 to solution specific recommendations grouped according to classifications of similar issues as established at 1043. The engine then validates 1051 the efficacy of the teams as well as the proposed areas for particular recommendations. A negative determination of team composition validity triggers a recalculation of 1043 with data excluded from the process so that that team composition is reorganized with the negative determination added in the feedback loop. Once the team composition 1049 receives a position determination 1051, the established team is automatically tasked with the sorted solutions. The system prompts designated solutioning reports from individuals within the population from a designated team. The system stores information from these respective reports in a solutions repository 1053. In addition to storing the reports, the system automatically generates a query for the solution evaluation module 1055. From this module, users are able to select specified types of recommendations from a pre-populated list of multiple options. Based on the selected set of queries, the system queries a preset population similar to 1043. The system uses the resultant outputs to determine whether the initial specified business problems have been sufficiently addressed 1065. Unresolved issues are re-circulated through the solutions engine 1043 with previous calculations added as a part of the feedback loop. If the system determines issues have been sufficiently addressed, the solutions and accompanying actions are stored in an issue resolution database 1069.

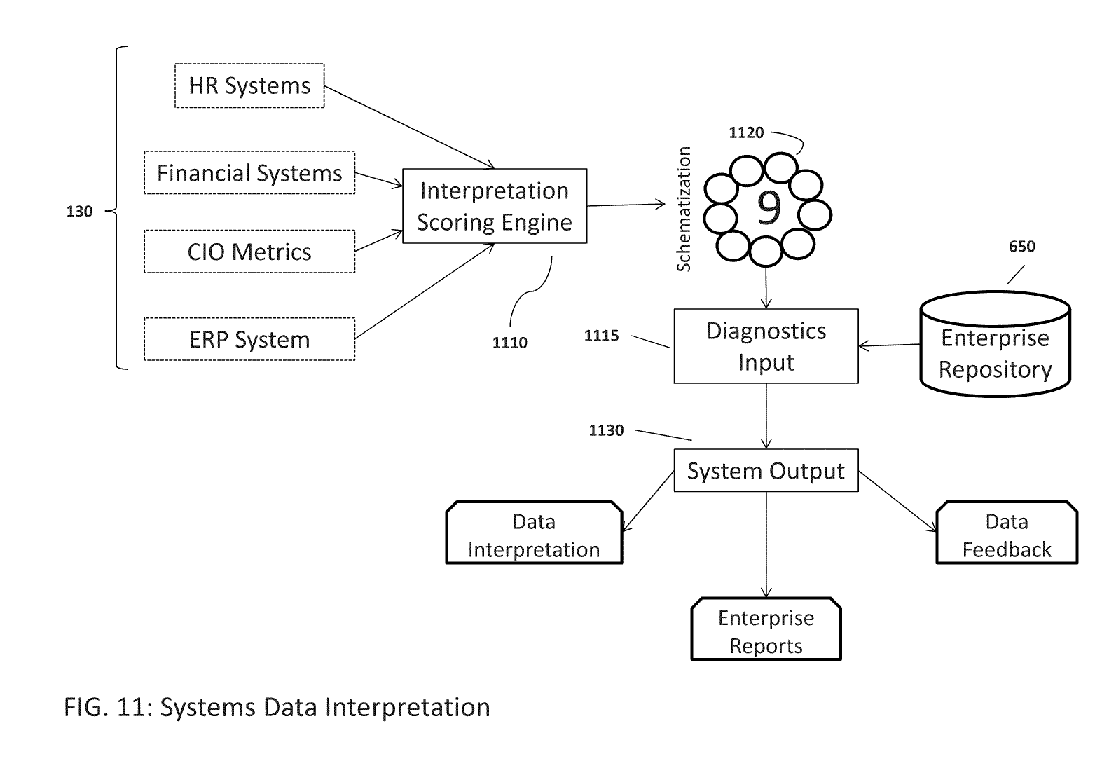

FIG. 11 is a schematic diagram of an example system for collecting systems data into the interpretation and scoring logic system and aggregating the data and building it into the schema. As shown, internal data 130 that is not system exclusive is transformed into schema useable data by assigning a schema useable score to the data. The score is assigned by an interpretation scoring engine 1110 pursuant to the selected schema (e.g., a score of 1-9) based on predetermined conversion algorithms or tables. The scores are then input into schema specific locations at step 1120 and applied as diagnostics input 1115 to diagnostics from the enterprise repository 650 for use in system output 1130 such as data interpretation, company reports and data feedback.

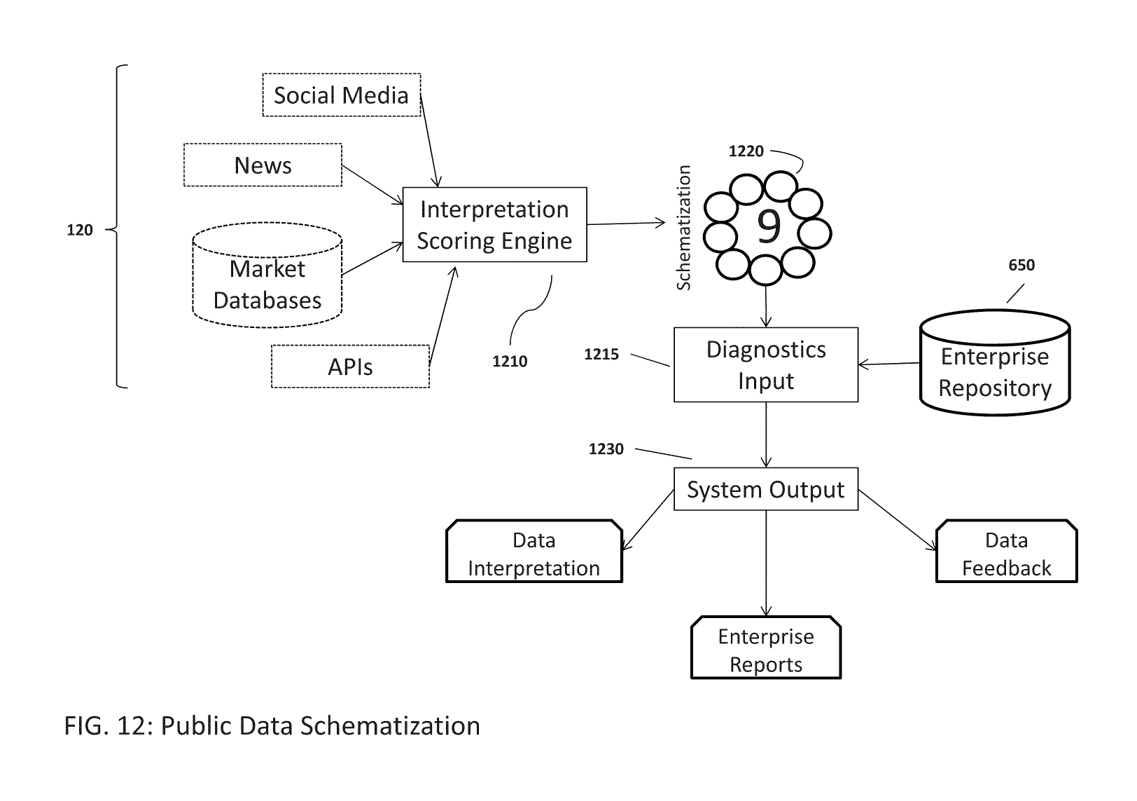

FIG. 12 shows the system used in a process for collecting assorted public (external) data 120 and systematizing the information based on an interpretative scoring process and sequencing it into a logical framework. As shown, external data 120 is transformed into schema useable data by assigning a schema useable score to the data. The score is assigned by an interpretation scoring engine 1210 pursuant to the selected schema (e.g., a score of 1-9) based on predetermined conversion algorithms or tables. The scores are then input into schema specific locations at step 1220 and applied as diagnostics input 1215 to diagnostics from the enterprise repository 650 for use in system output 1230 such as data interpretation, company reports and data feedback.

FIG. 13 shows the system for generating specific population lists to be queried based on predetermined inputs that in turn generate an automatically selected population for sessions based on determinant algorithms and comparisons. As shown, a parameter selection interface 1310 allows the user to set parameters based on factors such as segmentation, previous participation (and performance) and weighting of criteria. Based on the parameters set and data drawn from a HR database 1320, an automated selection engine 1330 generates a population selection report 1340 for user review at step 1350. If the report 1350 is approved, it is used in an app session at step 1360 and eventually results in a statistical report 1370. If the report is not approved at step 1350, the user selections participants to be removed and the process returns to the automated selection engine 1330.

The system shown in FIG. 13 may thus be used for automatically calculating a statistically significant population for addressing specific business problems. Likewise, the system may be used to invite the statistically significant population to an application, and determine their representative perspective based on relative calculations of the deviation of initial population participants. The system acts as a decision engine that uses relative A/B testing preferences to determine significant issues and workflows for determining which populations are expert in which topics.

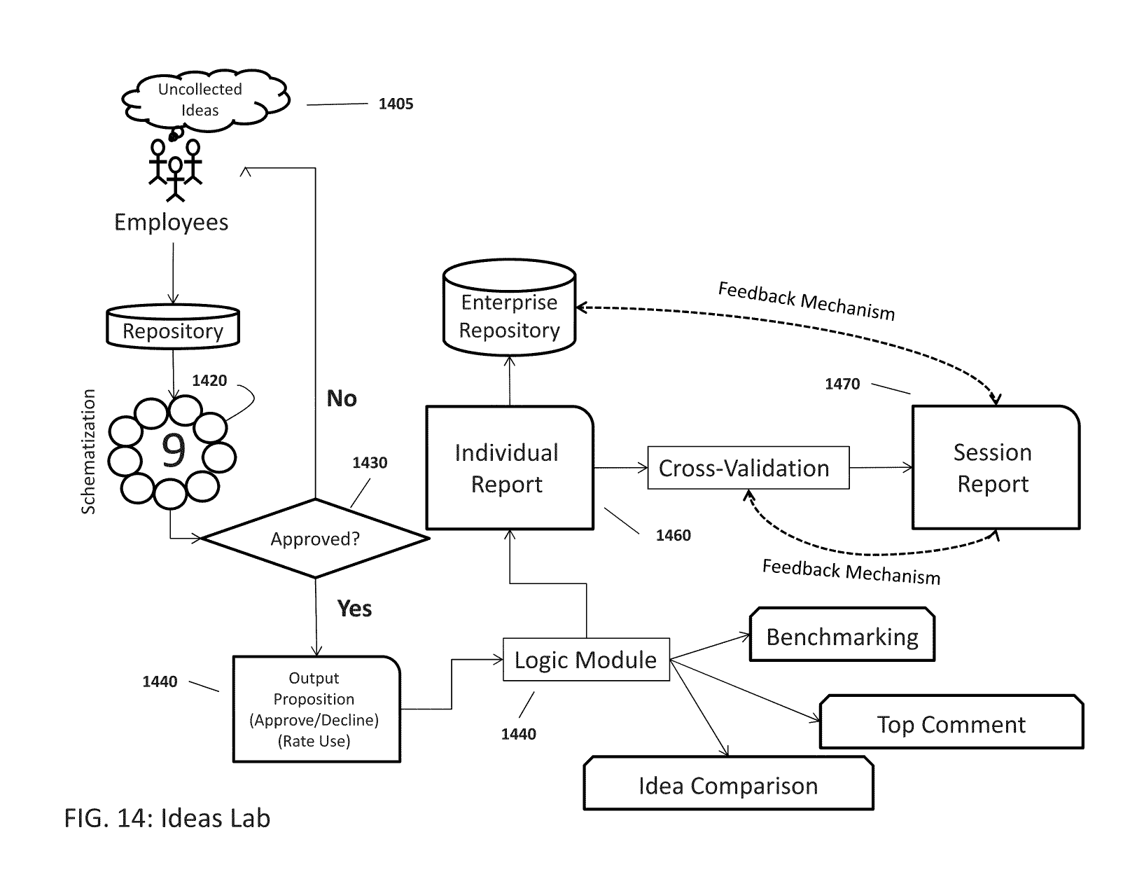

FIG. 14 shows the system used for creating business solutioning ideas within the organization. The system solicits uncollected ideas from employees 1405 and includes a repository 1410 for storing and processing the ideas. The data is schematized at step 1420 and at step 1430 the idea is approved or rejected (presumably by a manager). If approved, the idea may be reformatted and rated as an output proposition 1440 for further consideration and rating. A logic module 1450 includes algorithms for selecting best comments/ideas, thumbs up/down rating for manual rating, algorithm for aggregating responses; use of the best data to determine consistent performance. Output from the logic module 1450 may include, for example, benchmarking reports, top comment reports and idea comparisons. The system further includes feedback loops for identifying and relating top solvers and best ideas to predictive solutions. As shown, ideas are associated with the individuals submitting them in an Individual Report 1460 and validated (or not) through future data and reports are generated on an entire session 1470. User data is also stored in an enterprise repository 1480 and used to identify top performers based on submissions over time. Process steps may be performed by software engines, agents or a combination of both.

FIG. 15A shows the system for presenting output according to an alternative schema format based on a master schema. In the example shown, the master schema is the 9Lenses schema. As shown, the user selects an alternative schema at step 1510. An analysis agent defines the components and sub-components of the alternative schema at step 1515. The agent then maps the components and subcomponents of the alternative schema to the master schema (step 1520). In addition, at step 1525 the agent identifies externalities, i.e., inputs required by the alternative schema that cannot be mapped from the master schema. To the extent externalities exist, it becomes necessary to define and implement a data collection strategy to satisfy the externalities. At step 1530, an available data source that is relevant to one or more of the schema components is identified and a strategy for collecting the relevant data is designed and implemented. The relevant data is collected and stored at step 1540. The process is repeated (step 1550) so long as there are relevant data sources. It will be appreciated that the agent described above maybe an automated software agent, a human agent or a combination of both. Once externalities are fully satisfied, the proposed mapping and internal systems information are presented for review and approval at step 1560. If approved, mapped content is output at step 1570. If not approved, a reason for rejection is obtained and the system revalidates the proposal (at step 1580) and the process resumes at 1525.

Similarly, FIG. 15B shows an example of a system for extracting and presenting translated content from alternative schemas into a format based on a master schema. In this example, the analyst agent translates content from a relevant book on business expertise 1505 according to the collection of external research 1513 and previous information on the development of business procedures 1515. The resultant diagnostic 610 is translated into a master schema 1520. At step 1530, the agent generates a refinement of the diagnostic according to pre-established criteria on comparison to known business problems 1533, quality of the language used as it relates to traditionally accepted terminology 1535 and investigative strength of the diagnostic according to the likelihood of eliciting useful responses. The refinement is presented for review and approval 1540. If approved, the diagnostic content is output at step 1560 and then stored in the diagnostic repository 670. If not approved, a reason for rejection is obtained and the system revalidates the diagnostic (at step 1550) and the process resumes at 1530.

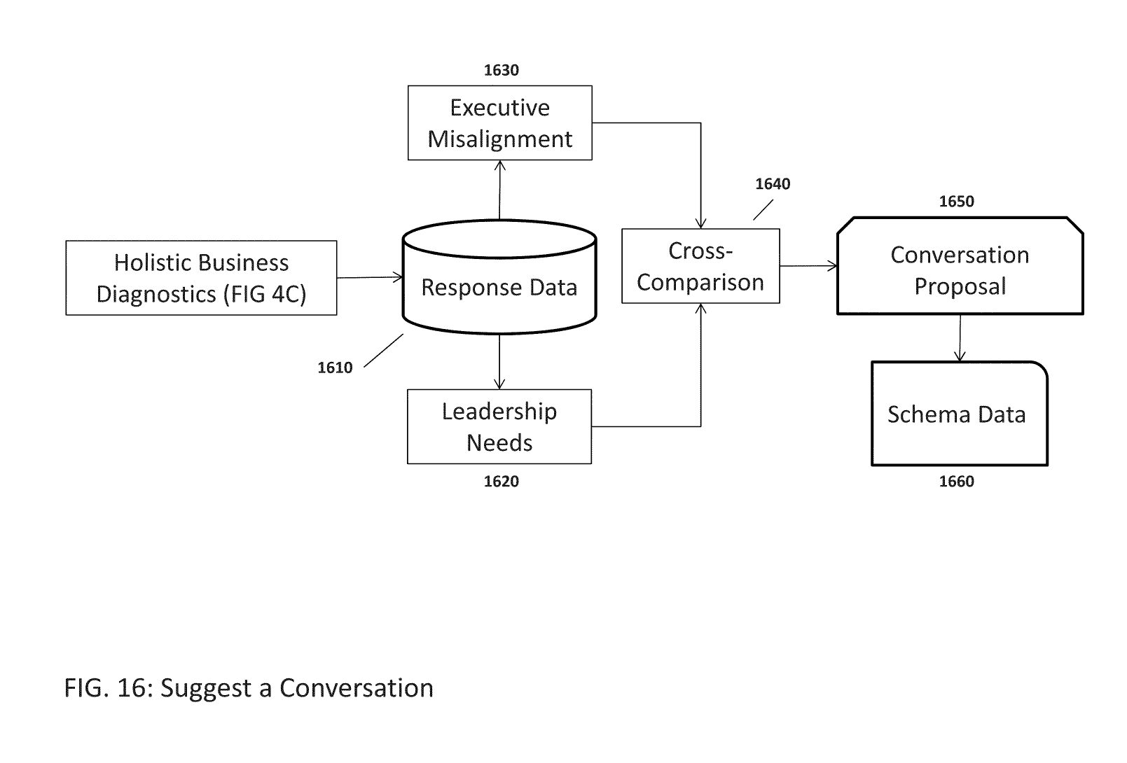

FIG. 16 shows a system for automatically recommending business conversations based on the data obtained from the holistic business diagnostics (as shown in FIG. 4C). The system extracts data from responses 1610 to determine the statistically significant misalignment of scores between executives 1620 and specified needs identified by leadership 1630. The system then compares this data with identified areas of concern from previous data 1640. The resulting comparisons of data are output as a proposal for which business problems should be evaluated 1650. Ideally, the system further includes a display with specific data within the schema from which the proposal was generated 1660.

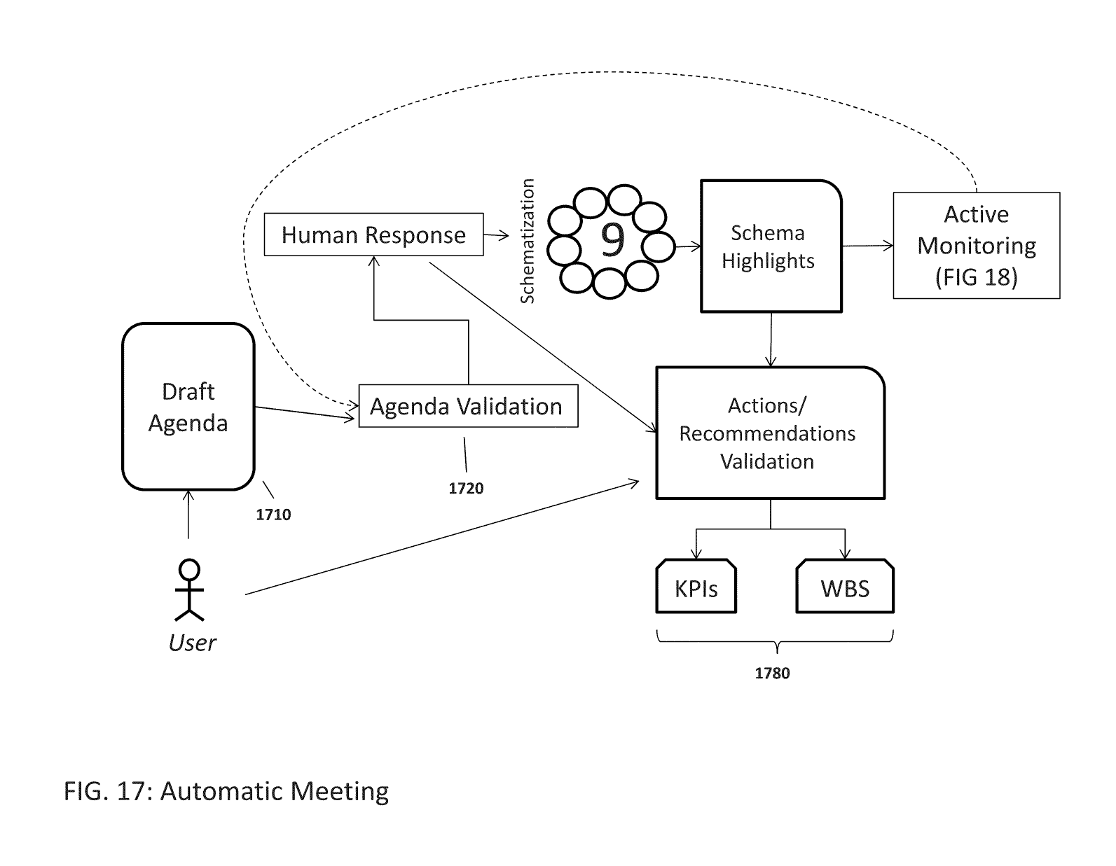

FIG. 17 shows the system that automates meetings. As shown, users create draft agendas 1710 in the system. The agendas are validated 1720 through manual confirmation from other participants and system-generated preferences from system specific data. At step 1730, the system filters the human responses, these responses are then schematized 1740. At step 1750, the system creates areas of importance according to the schema components and sub-components. The system may use active monitoring 1760, further described in FIG. 18, as a feedback loop to confirm the accuracy of the system-generated preferences. The system generates an actions and recommendation report 1770, which users and participants may then validate according to their own preferences. The system may then provide outputs on the validated actions 1780.

As the system collects data from a plurality of sources, the user may monitor the general trends in the usefulness of information that the system collects from different systems. As shown in FIG. 18, the system monitors individual inputs using decision logic modules to generate recommendations on how sources should be weighted. Data from a plurality of sources, 120, 410, and 130 for example, is aggregated 1810, similar to the system in FIG. 2, and passed to an interpretation engine 1820 for transformation into schema data according to a master schema 1830. At step 1840, the user may select criteria for preferences regarding data sources according to the decision logic engine. The system consistently tracks the inputs from the schematized data and the selections made in the engine. The engine outputs recommendations for data weighting 1850 according to the resultant information from the output feedback and the decision logic engine.

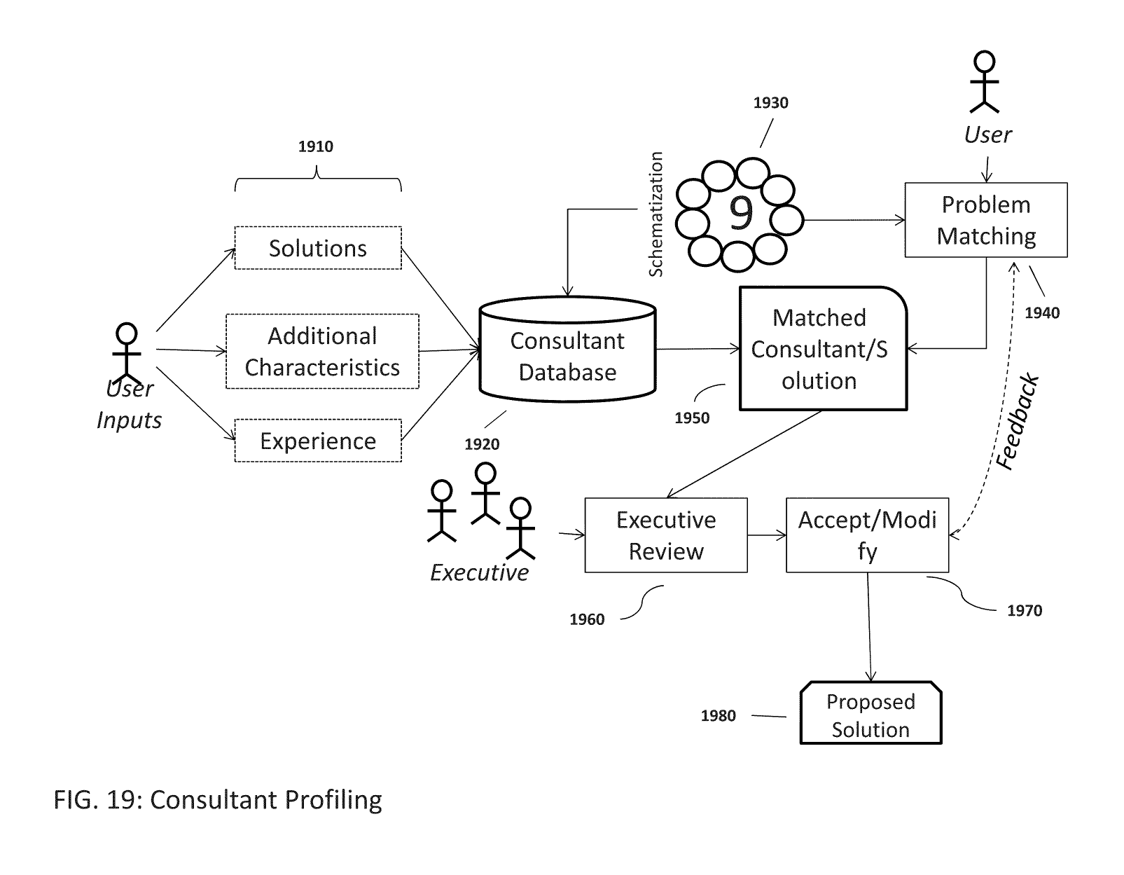

FIG. 19 shows the system used for matching consultant-generated solutions concerning specific enterprise related issues. As shown in step 1910, users input solution data based on established criteria (preferably solution implemented, relevant characteristics of consultant, and experience in field). Solutions data may be stored in a database 1920. The system then schematizes the data pursuant the main schema 1930. Step 1940 shows the users generate data on specific enterprise problems. The data is input into a problem-matching engine that associated the specific problem with the main schema 1930 and generates matching recommendations for the solutioning the enterprise problems 1950. The recommendations may then be evaluated by the respective executives managing the enterprise issue 1960. The system uses the feedback generated by the executives to further improve the problem matching engine suggestions 1970. The system then generates a proposed solution report 1980.

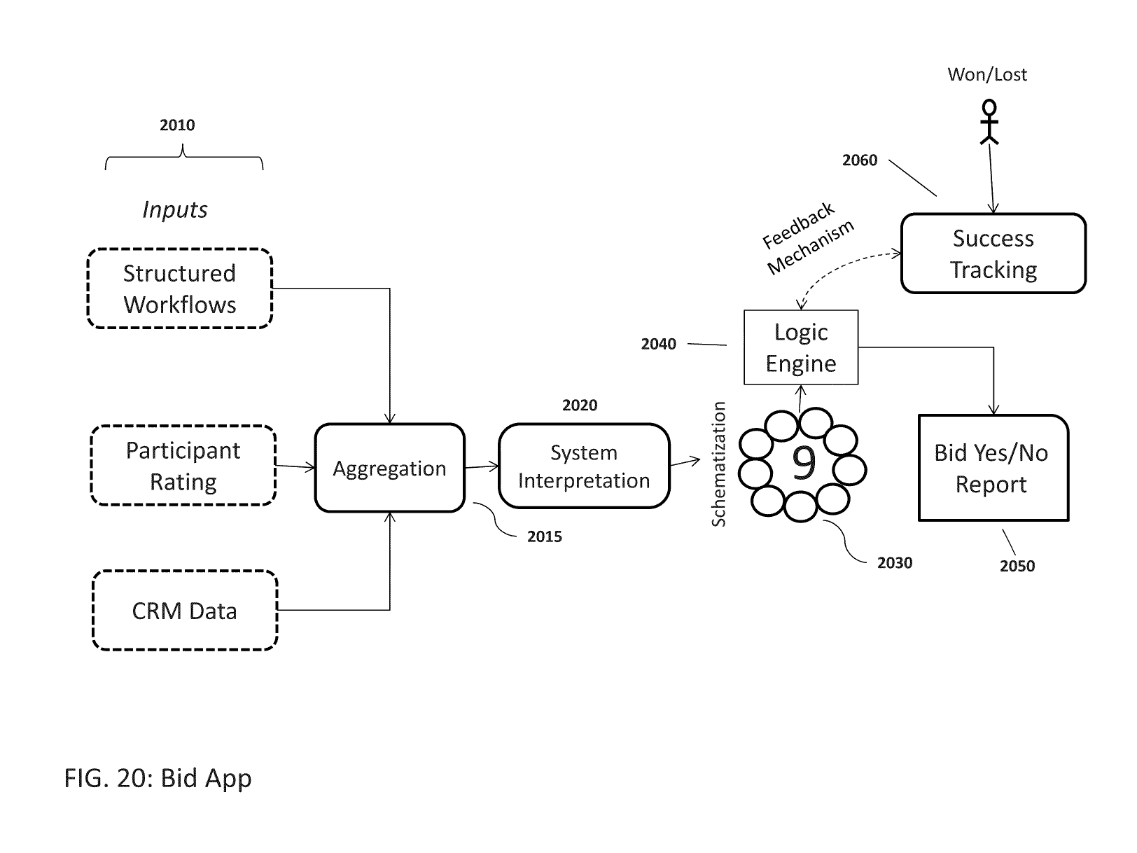

According to aspects of the present invention, there may be multiple systems for automating enterprise processes. For example, FIG. 20 shows the system for automating bid/no bid decisions on contracts. Data from existing workflows, ratings from participants, and corporate resource management 2010 is aggregated 2015 and passed into an interpretation engine 2020 for transformation into the main schema 2030. A logic engine 2040 processes the schematized data. The logic engine may then output a bid/no-bid report detailing predictive success from the data. Step 2060 validates the actual decision. Users indicate the wins and losses on specific bid and input reasons for the outcome. The system generates comparative reviews of these reasons for improving the accuracy of future predictions.

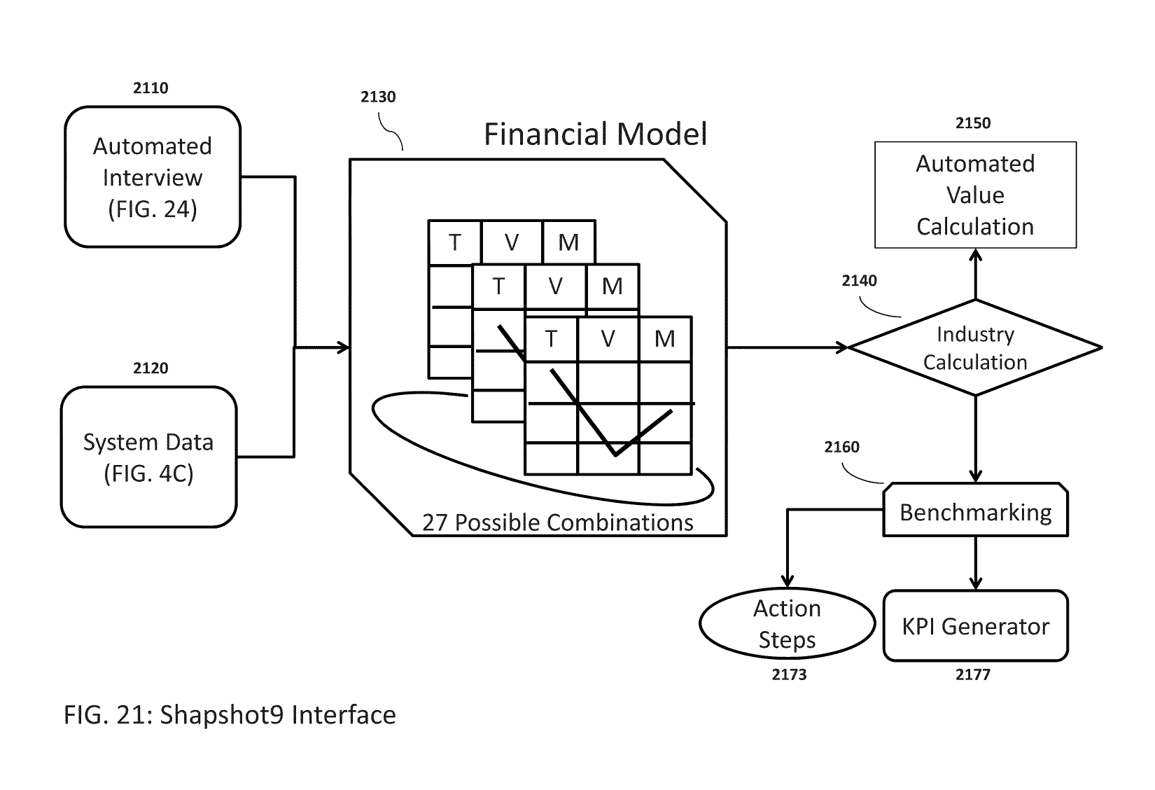

FIG. 21 shows an example system for automatically determining the financial model of an enterprise. The system pulls data generated from automated interviews 2110, further illustrated in FIG. 24, and system data 2120 targeted around financial information. The system displays an output model of the aggregated information 2130 according to three criteria (touch, volume, and margin). The system compares data from the output model to available industry data within the system and publically available data 2140. The system generates an automated value estimate 2150 that, preferably, provides a “best in class” comparison financial models. The system also displays a benchmarking report 2160 that provides information for strategic improvement of the financial model. The system generates a KPI report 2177 and displays particular action steps 2173 for recommended actions for altering an enterprise financial model.

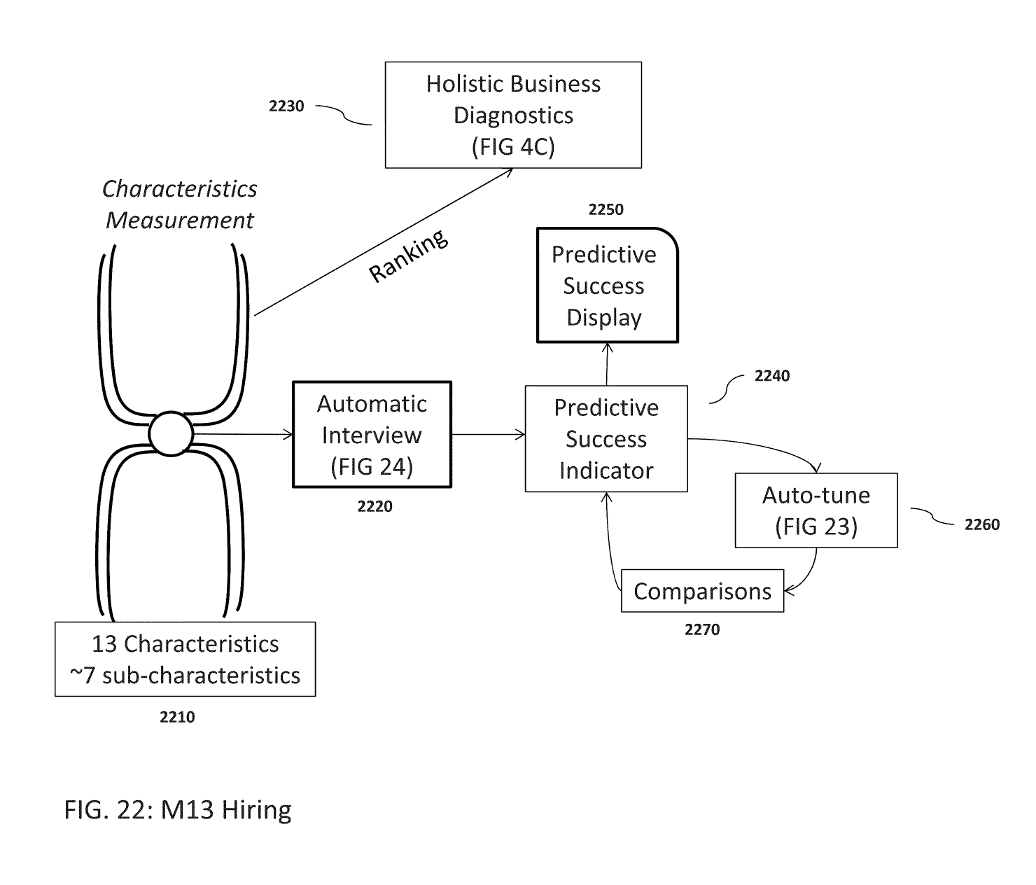

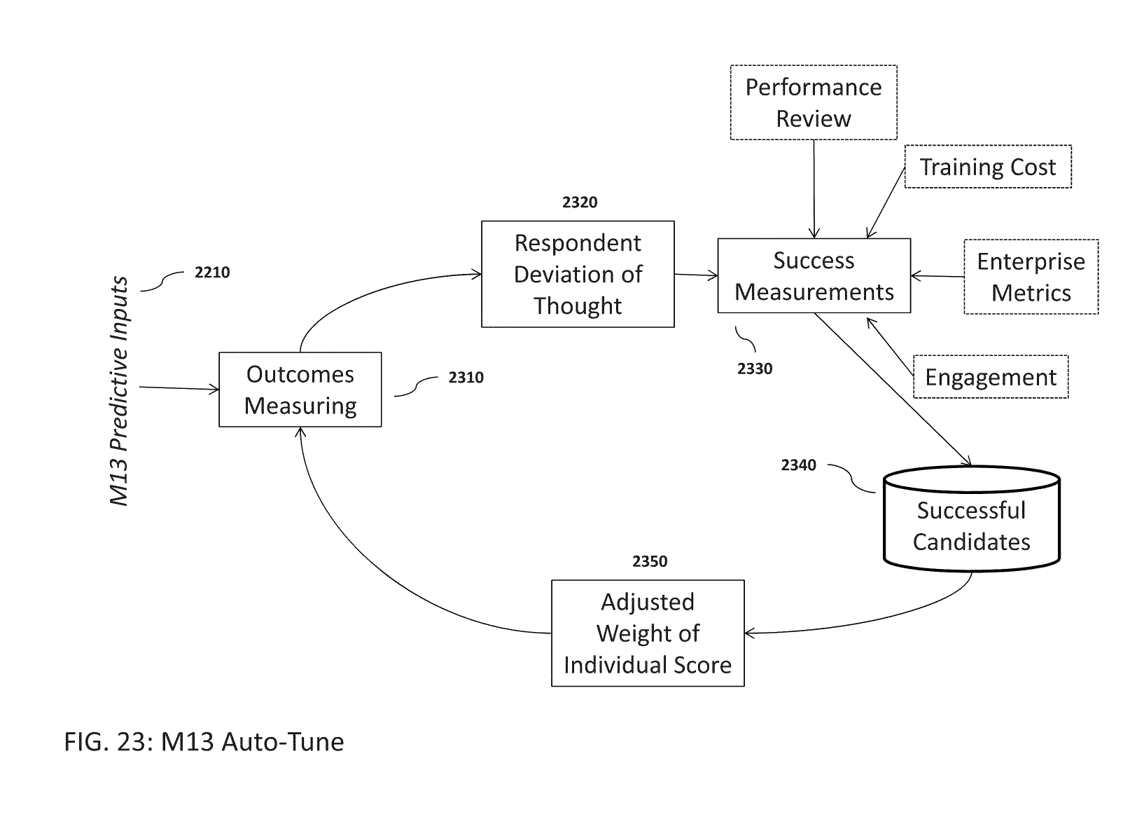

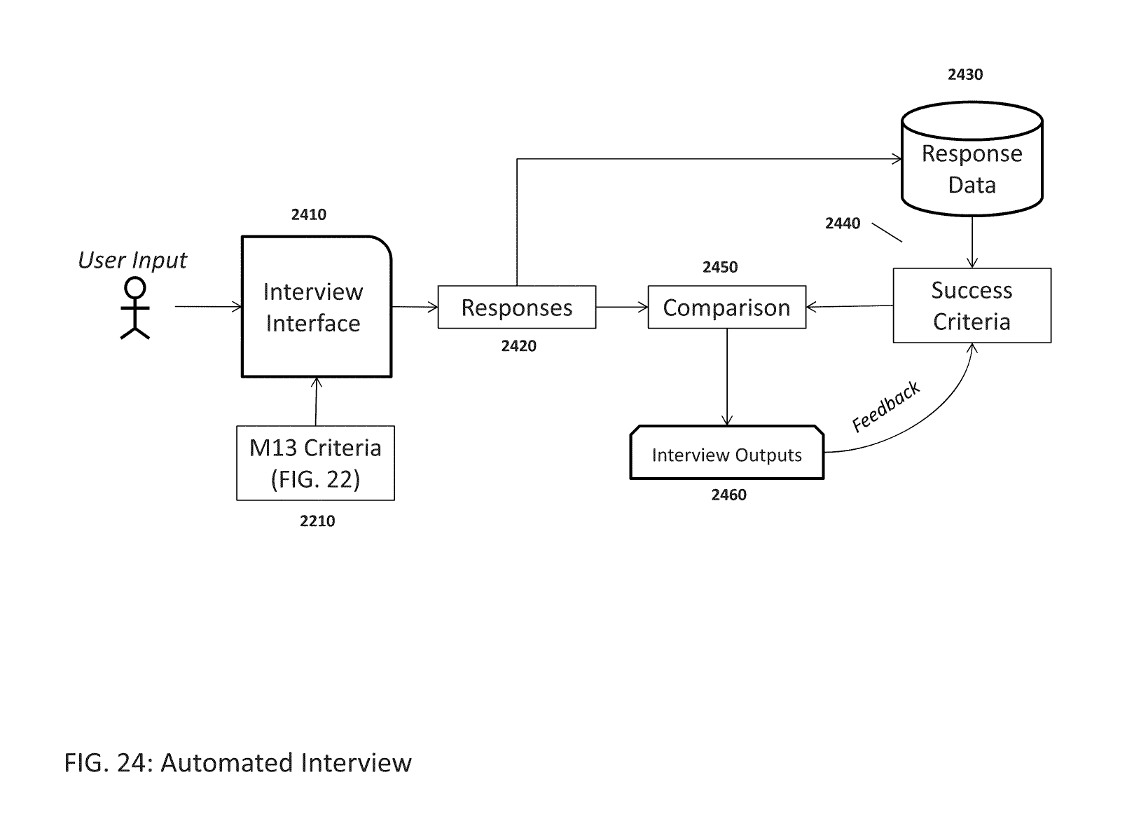

The system may provide a system that automatically interviews candidates for employment. As shown in FIG. 22, the system queries the user based on pre-determined characteristics 2210. The system then feeds those inputs into the automatic interview engine 2220, further illustrated in FIG. 24. The system is further comprised of a ranking integration for classified data 410, as illustrated in FIG. 4C. The system pulls the resultant data from automated interviews to generate a predictive probability for successful performance of the candidate within the enterprise role according to the predictive success indicator engine 2240 and outputs a display of the results accordingly 2250. The system is further comprised of a self-correcting feedback loop that pulls information from the auto-tuned feature 2260, further illustrated in FIG. 23. The system creates a corrective formulation for comparisons 2270 that feeds into the calculations provided by the predictive success indicator engine.

FIG. 23 shows an example system for automatically calibrating the predictive success of job applicants from automatic interviews based on successes of previous candidates. The system pulls user inputs from the pre-determined characteristics 2210. The outcomes measuring engine 2310 provides an approximated value for current user responses by assigning a numerical value to their responses. The system generates a deviation score for estimating how much the respondent differs from the predictive model for a successful candidate 2320. The system compares the deviation score with the results of the success measurement engine 2330, which uses standardized measurements from a plurality of inputs (for example, performance review, training costs, established enterprise performance metrics, and employee engagement). The system outputs the data of successful candidates and stores them in a repository 2340. The data from the repository is further used to adjust 2350 the estimated weighting of scores provided by the outcomes measuring engine.

FIG. 24 shows the system used for process responses from automated interviews. The system displays the M13 criteria 2210 in a standardized user interface 2410. Through the interface, users input responses 2420 to targeted queries. The responses are preferably input into a response database 2430. The system generates a success criteria 2440 preference that marks the data according to the pre-established success measurement categories, as described in FIG. 23. The raw responses and annotated responses and compared at step 2450 and the system outputs the resultant responses for use within the system 2460.

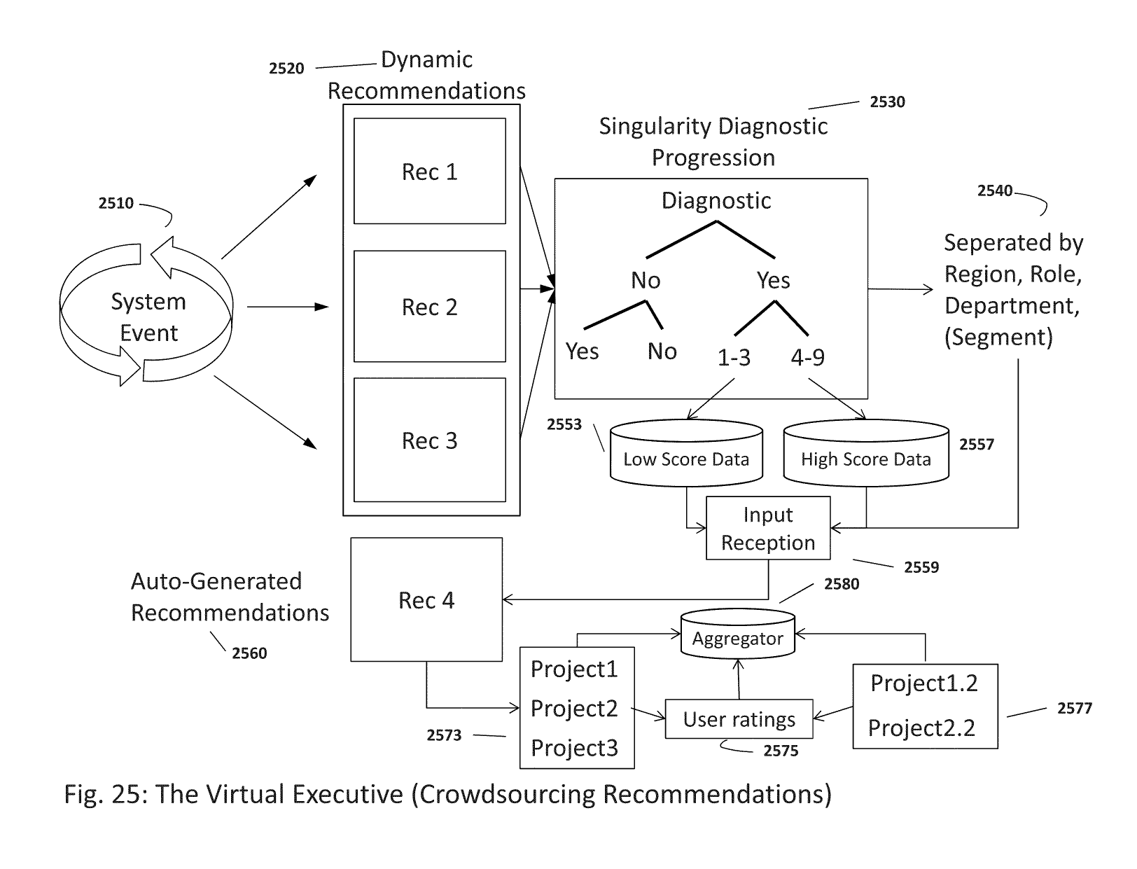

The system may further provide a. example virtual executive decision and recommendation engine as shown in FIG. 25 and described below. As shown, the virtual executive decision and recommendation engine automatically generates and outputs data structures that display or otherwise output recommendations in response to receipt of data structures representing some specified event. The predictive engine could, for example, be used to generate targeted recommendations for building a marketing strategy, assigning members of a specific team to build the strategy, and then evaluating the viability of the team's plans. Beginning from the receipt of data structures that result from a system event 2510 triggered either by a user specified occurrence or by pre-determined criteria, the system generates data structures that display or otherwise output dynamic recommendations 2520 by querying previously given responses from users and automatically grouping the inputs into displayed recommendations. Each recommendation is filtered into the singularity diagnostic progression 2530, which dynamically filters relevancies based on the constant signals from users in specific diagnostics. The diagnostics are systematized based on user generated inputs and comparatively mapped to specific relevancies (e.g., application of previous diagnostic responses to the current event) according to the relative scoring input (e.g., user rates a system query as low) given within the interview engine. Based on these scores, the predictive engine distributes inputs from legacy data of recommendations. The inputs are individually filtered according to specified segments 2540 that classify the inputs according to pre-defined categorizations. The predictive engine collects the segmented signals and legacy data into a centralized receptor 2559 that auto-generates data structures that display or otherwise output recommendations 2560 according to the signals transmitted. (If the relative scoring inputs are low, legacy data from similar interpretations may be used 2553. However, if the scoring inputs are high, legacy data from similar interpretations may be used 2557.) Based on these auto-generated recommendations, the predictive engine segments (assigns) users to system-generated projects 2573. Users have the functional ability to rate the viability of the system created projects 2575. Additionally, the predictive engine has a capability to generate revised versions of projected 2577 based on user ratings and additional user signals. The respective signals from 2573, 2575, and 2577 are distributed into the system's aggregator 2580, which stores the respective signals, inputs, and rated relevancies in the predictive engine to inform future projects.

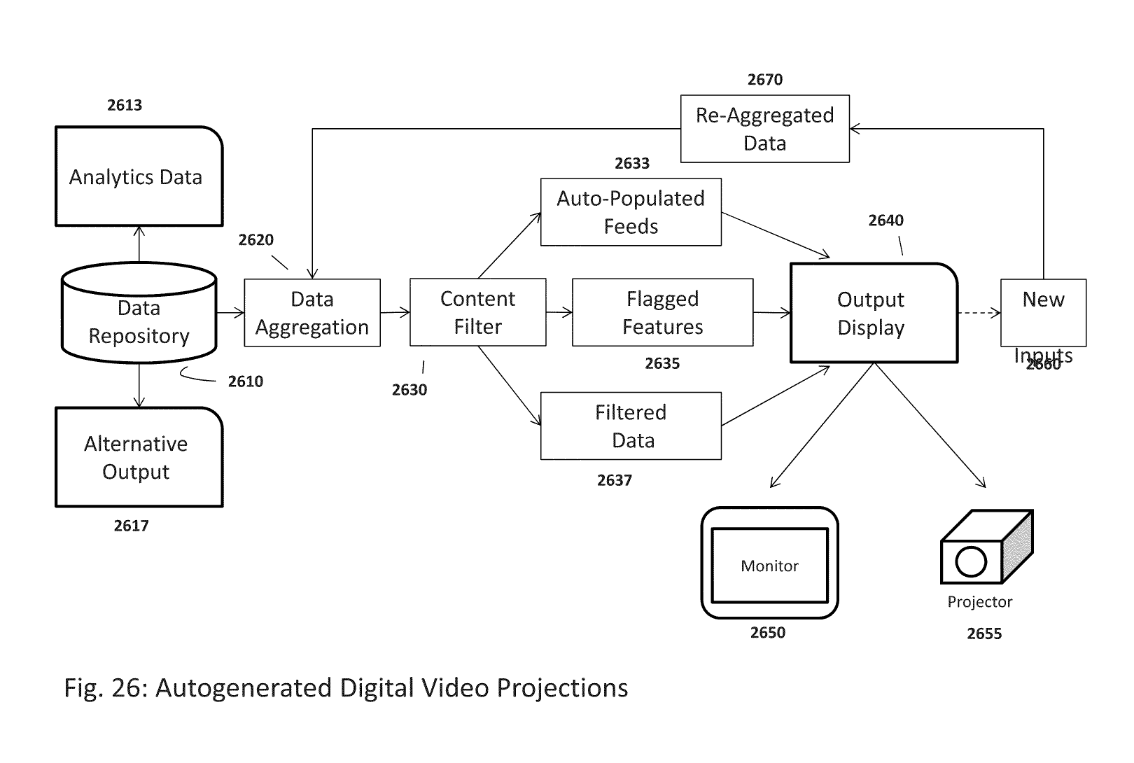

FIG. 26 shows a schematic diagram of an example automated system for filtering and transforming information data feeds from previously described engines into a dynamic visual display. Previously collected data is stored in a plurality of locations universally referred to in this figure as the data repository 2610. The repository directly outputs two primary displays of the data as either a direct analytics data display 2613 (e.g., strength and challenge ratings, score of specific diagnostics) or as an alternative display of the plurality of variables 2617 (e.g., user defined displays). Alternatively, the system aggregates the data 2620 from the system's various locations that are fed into a content filter 2630 that combines individual data fields with elements of a preset output display. From the content filter, data is separated according to automatically populated elements of the preset output display 2633, user flagged features 2635 from the data repository, and automatically filtered data 2637 according to the systems unit logic. Each component is filtered into a dynamic output display 2640 that is visually presented with an appropriate display such as a monitor 2650 or projector 2655. As additional inputs 2660 are added to the entire system—either through direct user input or through alternative means through 2610—the system will accordingly re-aggregate the data 2670 so that the content filtered through the output display changes in real time while other displays of the data are being projected.

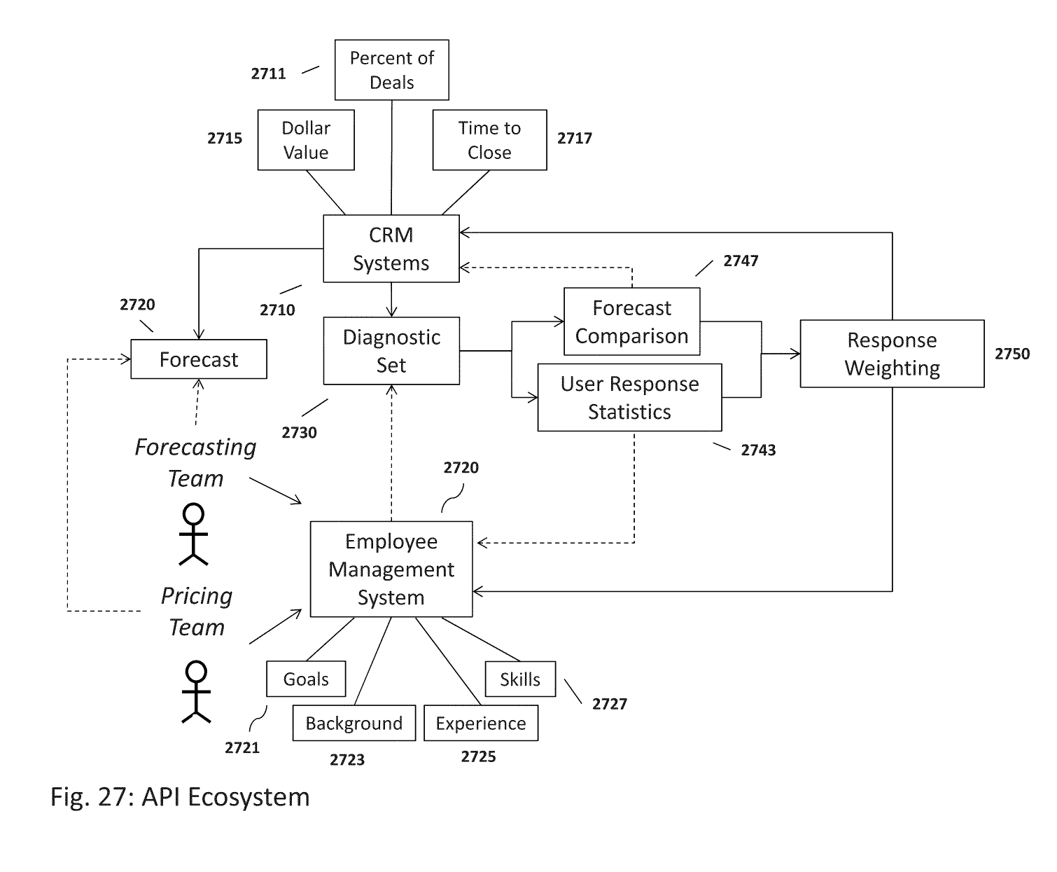

Another aspect of the invention as presented is an engine, shown in FIG. 27, for interacting with external systems in order to transform existing data into enterprise-relevant comparative metrics. The engine leverages standard data, such as 2711, 2715, and 2717, provided by a customer relationship management (CRM) system 2710 about sales opportunities and deals documented by individual enterprises. Through an application programming interface (API), an agent can query diagnostic set 2730 regarding a specified population to validate operational perspectives. In accordance with aspects of the present invention, the agent can provide a human or a machine response to pre-determined system specified events. The engine populates a participant pool using information collated from an integrated employee management system (e.g., workday). Participant responses are calculated and simultaneously processed according to the forecast comparison 2747 and the user response statistics 2743. The forecast comparison directly assesses the accuracy of the initial human generated forecast 2720 to the engine calculated estimation based on the participant assessments. The engine provides a score, which is then associated with the participant who provided the initial forecast and vetted to the response weighting 2750. Similarly, the participant's engagement statistics (word count, relevance of comments, importance of comments, areas of expertise, etc) are evaluated 2743 and added to the employee management system 2720. Both the forecasting comparisons 2747 and the user response statistics 2743 are processed into weighted dynamic scores associated with future participant inputs to CRM data and employee management system information.

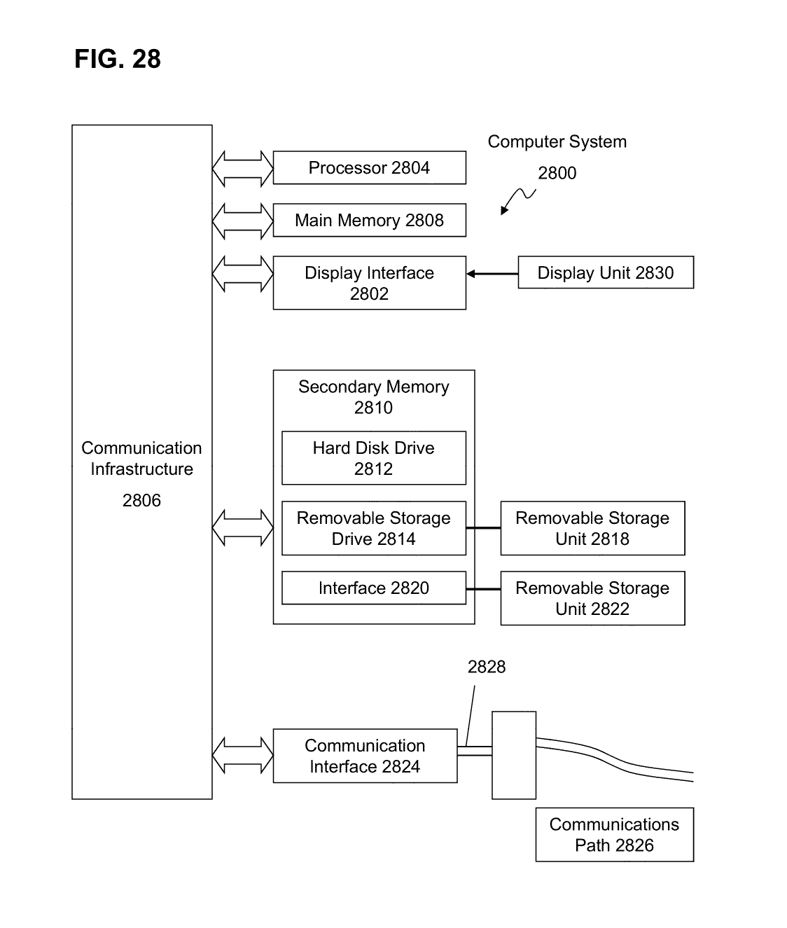

In some variations, aspects of the present invention may be directed toward one or more computer systems capable of carrying out the functionality described herein. An example of such a computer system 2800 is shown in FIG. 28.

Computer system 2800 includes one or more processors, such as processor 2804. The processor 2804 is connected to a communication infrastructure 2806 (e.g., a communications bus, cross-over bar, or network). Various software aspects are described in terms of this example computer system. After reading this description, it will become apparent to a person skilled in the relevant art(s) how to implement the invention using other computer systems and/or architectures.

Computer system 2800 can include a display interface 2802 that forwards graphics, text, and other data from the communication infrastructure 2806 (or from a frame buffer not shown) for display on a display unit 2830. Computer system 2800 also includes a main memory 2808, preferably random access memory (RAM), and may also include a secondary memory 2810. The secondary memory 2810 may include, for example, a hard disk drive 2812 and/or a removable storage drive 2814, representing a floppy disk drive, a magnetic tape drive, an optical disk drive, etc. The removable storage drive 2814 reads from and/or writes to a removable storage unit 2818 in a well-known manner. Removable storage unit 2818, represents a floppy disk, magnetic tape, optical disk, etc., which is read by and written to removable storage drive 2814. As will be appreciated, the removable storage unit 2818 includes a computer usable storage medium having stored therein computer software and/or data.

In alternative aspects, secondary memory 2810 may include other similar devices for allowing computer programs or other instructions to be loaded into computer system 2800. Such devices may include, for example, a removable storage unit 2822 and an interface 2820. Examples of such may include a program cartridge and cartridge interface (such as that found in video game devices), a removable memory chip (such as an erasable programmable read only memory (EPROM), or programmable read only memory (PROM)) and associated socket, and other removable storage units 2822 and interfaces 2820, which allow software and data to be transferred from the removable storage unit 2822 to computer system 2800.

Computer system 2800 may also include a communications interface 2824. Communications interface 2824 allows software and data to be transferred between computer system 2800 and external devices. Examples of communications interface 2824 may include a modem, a network interface (such as an Ethernet card), a communications port, a Personal Computer Memory Card International Association (PCMCIA) slot and card, etc. Software and data transferred via communications interface 2824 are in the form of signals 2828, which may be electronic, electromagnetic, optical or other signals capable of being received by communications interface 2824. These signals 2828 are provided to communications interface 2824 via a communications path (e.g., channel) 2826. This path 2826 carries signals 2828 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 2814, a hard disk installed in hard disk drive 2812, and signals 2828. These computer program products provide software to the computer system 2800. The invention is directed to such computer program products.

Computer programs (also referred to as computer control logic) are stored in main memory 2808 and/or secondary memory 2810. Computer programs may also be received via communications interface 2824. Such computer programs, when executed, enable the computer system 2800 to perform the features of the present invention, as discussed herein. In particular, the computer programs, when executed, enable the processor 2810 to perform the features of the present invention. Accordingly, such computer programs represent controllers of the computer system 2800.

In an aspect where the invention is implemented using software, the software may be stored in a computer program product and loaded into computer system 2800 using removable storage drive 2814, hard drive 2812, or communications interface 2820. The control logic (software), when executed by the processor 2804, causes the processor 2804 to perform the functions of the invention as described herein. In another aspect, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another aspect, the invention is implemented using a combination of both hardware and software.

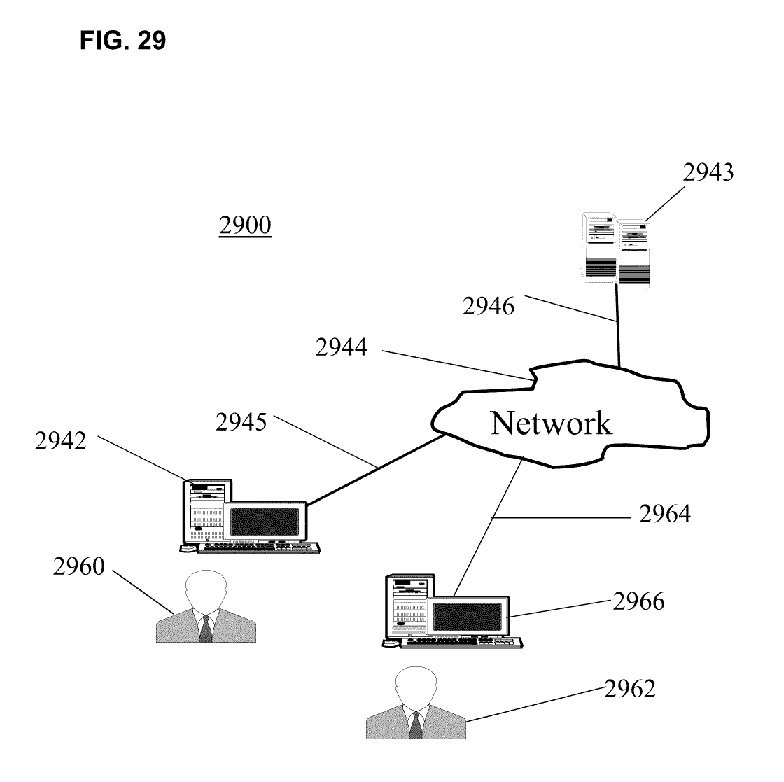

FIG. 29 shows a communications system 2900 involving use of various features in accordance with aspects of the present invention. The communications system 2900 includes one or more assessors 2960, 2962 (also referred to interchangeably herein as one or more “users”) and one or more terminals 2942, 2966 accessible by the one or more accessors 2960, 2962. In one aspect, operations in accordance with aspects of the present invention is, for example, input and/or accessed by an accessor 2960 via terminal 2942, such as personal computers (PCs), minicomputers, mainframe computers, microcomputers, telephonic devices, or wireless devices, such as personal digital assistants (“PDAs”) or a hand-held wireless devices coupled to a remote device 2943, such as a server, PC, minicomputer, mainframe computer, microcomputer, or other device having a processor and a repository for data and/or connection to a repository for data, via, for example, a network 2944, such as the Internet or an intranet, and couplings 2945, 2964. The couplings 2945, 2964 include, for example, wired, wireless, or fiberoptic links. In another aspect, the method and system of the present invention operate in a stand-alone environment, such as on a single terminal.

As described above, the system uses various engines and agents to perform specified functions. The engines are preferably implemented as general purpose computing devices controlled by software to perform as special purpose engines. The computing device(s) on which the system is implemented communicate with other system components and external system systems and users through conventional communications protocols and interfaces. The agents used or interacting with the system may be automated agents or human agents or combinations of both.

The aspects described herein are examples and variations of aspects of the present invention, and are not intended to be exhaustive of the applications of the systems and methods of the present invention.

What is claimed is:

1. A system for presenting data according to a framework of a selected schema, comprising:
a communications sub-system configured to provide network communications with a plurality of data sources;
a query engine connected to the communications sub-system configured to request data from a plurality of data sources;
a database configured to store data received from the data sources;
an interpretation engine configured to transform the data received from the data sources into schema data according to the selected schema; and
a system output engine and user interface configured to display the schema data and to allow a user to access the data from the data sources upon which the schema data is based.

2. The system for presenting data according to claim 1, further comprising:
a mapping engine configured to map data in the database to a selected schema by mapping the selected schema to a master scheme.

3. The system for presenting data according to claim 1, further comprising:
a data filter control configured to allow a user to selectively remove selected data sources from the data sources upon which the displayed schema data is based.

4. The system for presenting data according to claim 1, further comprising:
a database containing industry data and a comparison engine configured to compare enterprise data to industry data and to display a resulting comparison.

5. The system for presenting data according to claim 1, wherein the data sources include persons responding to queries through the communications sub-system.

6. The system for presenting data according to claim 1, wherein the data sources include internal databases responding to queries through the communications sub-system.

7. The system for presenting data according to claim 1, wherein the data sources include external databases responding to queries through the communications sub-system.

8. The system for presenting data according to claim 1, further comprising
an engine configured to determine a touch, a volume, and a margin of a business based upon the data sources.

9. The system for presenting data according to claim 1, further comprising:
a recommendation engine configured to make recommendations for altering a financial model of a business based upon the data sources.

10. The system for presenting data according to claim 1, further comprising:
a publication control engine configured to allow a user automatically publish content to specified board members.

11. The system for presenting data according to claim 1, further comprising:
an evaluation engine configured to evaluate business suggestions submitted from the data sources through reference to ratings of the suggestions and data regarding the source and track record of a rating source.

12. The system for presenting data according to claim 1, further comprising:
a logic engine configured to produce statistical comparisons between business data.

13. A system for dynamically generating presentations of data relevant to a selected business analytical schema comprising:
a communications sub-system comprising hardware configured to provide end-to-end connectivity according to a communications protocol to allow transmitting and receiving data within the system and among the system and external data sources and users;
data storage for storing data used by the system;
a user interface;
at least one general purpose computer that includes at least one CPU with on board RAM;
an input/output system bus;
system memory, the general purpose computer being capable of executing software programs to implement software engines, the computer being in communication with the communications sub-system, user interface, and data storage; the engines implemented including at least a query engine a schematic interpretation engine and a data weighing engine, wherein the query engine is connected to the communication system for requesting data from a plurality of data sources, the interpretation engine and data weighing engine are adapted to transform data received from the data sources into schema data according to the selected schema; and
a system output engine and user interface configured to display the schema data and to allow a user to access the data from the data sources upon which the schema data is based.

14. The system for dynamically generating presentations of data according to claim 13, further comprising:
a decision engine configured to receive user selection of priorities and preferences and to retrieve stored diagnostics to generate an app composed of stored diagnostic queries;
an executive decision engine configured to receive and store recommendations and selectively output stored recommendations in response to system events;
internal and external data feeds configured to populate a database of system content and to provide a marketplace to allow purchase of system content through the marketplace;
a team building engine configured to group agents into team units for addressing a specified enterprise issue, the team building engine further configured to assign the agents to team units based upon agent input in response to selected diagnostics and agent response to stored recommendations; to receive solutions to an issue from the team units, to evaluate the solutions received and to determine whether the solutions received solve the issue.

15. The system for dynamically generating presentations of data according to claim 13, further comprising:
a prediction engine configured to predict outcomes from separate business problems, the prediction engine using actual responses around specific components and sub-components and predicting responses to other schema queries that have established connections to queries for which actual responses have been received.

16. The system for dynamically generating presentations of data according to claim 13, further comprising:
a conversion system configured to present output according to an alternative schema format based on a master schema, the conversion system receiving a user selection as to an alternative schema and input from an analysis agent that defines the components and sub-components of the alternative schema and to map the components and subcomponents of the alternative schema to the master schema and to identify externalities for which the system must collect data from a source that is relevant to one or more of the alternative schema components, the conversion system prompting the user to approve proposed mapping and displaying approved mapped content.

17. The system for dynamically generating presentations of data according to claim 16, wherein the agent is an automated software agent.

18. The system for dynamically generating presentations of data according to claim 13, further comprising:
a data filter control configured to allow a user to selectively remove selected data sources from the data sources upon which the displayed schema data is based.

19. The system for dynamically generating presentations of data according to claim 13, wherein the data sources include external databases responding to queries through the communications sub-system.

20. A method for presenting data according to a framework of a selected schema, comprising:
providing network communications with a plurality of data sources;
requesting data from a plurality of data sources;
storing data received from the data sources;
transforming the data received from the data sources into schema data according to the selected schema;
displaying the schema data; and
allowing a user to access the data from the data sources upon which the schema data is based.
